(19) United States
(12) Patent Application Publication
(10) Pub. No.: US 2026/0299893 A1
(43) Pub. Date: Oct. 1, 2026

(54) AGENTIC MEMORY SYSTEM FOR EVOLVING CUSTOMIZED PROGRAM DEVELOPMENT PATTERNS

(71) Applicant: Amazon Technologies, Inc., Seattle, WA (US)

(72) Inventors: Shweta Garg, Sunnyvale, CA (US); Varun Kumar, Santa Clara, CA (US); Anoop Deoras, San Jose, CA (US); Murali Krishna Ramanathan, Los Altos, CA (US); Manikandan Srinivasan, San Jose, CA (US)

(21) Appl. No.: 19/092,382

(22) Filed: Mar. 27, 2025

(51) Int. Cl. G06F 8/33; G06F 40/30

(52) U.S. Cl. CPC G06F 8/33; G06F 40/30

(57) ABSTRACT

Disclosed are systems and methods for providing persistent, context-aware recommendations for IDE assistance tools. The disclosed systems and methods utilize a multi-layer memory architecture that includes a short-term memory and a long-term memory. The short-term memory stores representations of recent interactions and contextual information associated with a user for efficient retrieval, while the long-term memory stores patterns and preferences learned across multiple sessions (e.g., multiple sessions, multiple users, across an organization, etc.). The information stored in the short-term and long-term memories are managed and maintained based on various parameters, conflict resolution, implicit and explicit feedback signals, and the like. Recommendations are retrieved from the multi-layer memory using a weighted relevance function that is continuously optimized based on interactions with the user.

### BACKGROUND

Integrated development environments (IDEs) are software platforms that typically combine multiple developer tools into a single application to facilitate creation, building, testing, etc. of software code. Modern IDEs typically provide many assistance tools and features to help developers in writing code. For example, many modern IDEs provide assistance tools and features such as chat features, code completion features, and the like. Many such assistance tools and features rely on artificial intelligence (AI) systems, such as large language models (LLMs), in providing assistance to developers. Although such assistance tools and features provided by modern IDEs can be helpful, such assistance tools and features typically have significant drawbacks and limitations. For example, current IDE assistance tools and features typically operate in isolation within a single session. Accordingly, valuable contextual information is lost across different interactions, workflows (e.g., assistance tools, tasks, projects, etc.), coding sessions, and the like. Further, existing systems are unable to learn from interactions with users (e.g., developers, organizations, etc.) and the users'preferences, styles, patterns, and best practices. The lack of persistence across different interactions, workflows, and coding sessions, as well as the inability to learn and adapt to the needs and preferences of users (e.g., developers and organizations) presents a technical challenge to generate customized enterprise code at scale.

### BRIEF DESCRIPTION OF DRAWINGS

Various examples in accordance with the present disclosure will be described with reference to the drawings, in which:

FIGS. 1A and 1B are logical block diagrams illustrating an exemplary agentic memory system, according to exemplary embodiments of the present disclosure.

FIG. 2 is a block diagram illustrating a high level overview of an exemplary software development service and environment, according to exemplary embodiments of the present disclosure.

FIG. 3 is a block diagram that illustrates additional details of a software development service, according to exemplary embodiments of the present disclosure.

FIGS. 4A-4C are block diagrams of at least portions of an exemplary agentic memory system, according to exemplary embodiments of the present disclosure.

FIG. 5 is a flow diagram illustrating an exemplary information ingestion process, according to exemplary embodiments of the present disclosure.

FIG. 6 is a flow diagram illustrating an exemplary short-term information management process, according to exemplary embodiments of the present disclosure.

FIG. 7 is a flow diagram illustrating an exemplary long-term information management process, according to exemplary embodiments of the present disclosure.

FIG. 8 is a flow diagram illustrating an exemplary information feedback process, according to exemplary embodiments of the present disclosure.

FIG. 9 is a flow diagram illustrating an exemplary information retrieval process, according to exemplary embodiments of the present disclosure.

FIG. 10 is a block diagram illustrating an exemplary provider network (or “service provider system”) environment, according to exemplary embodiments of the present disclosure.

FIG. 11 is a block diagram illustrating an exemplary provider network environment that provides a storage service and a hardware virtualization service to customers, according to exemplary embodiments of the present disclosure.

FIG. 12 is a block diagram illustrating an exemplary computer system, according to exemplary embodiments of the present disclosure.

### DETAILED DESCRIPTION

Software developers typically use some form of text editor and/or development interface to aid in development of software code, often referred to as an integrated development environment (“IDE”). An IDE typically includes functionality that goes beyond text editing and provides an interface for different developer tools, documents, guidance, libraries, and/or other content that may aid the software developer in the development of code. As a result, developers can leverage an IDE environment to quickly begin developing code, rather than manually integrating and configuring different software. IDEs often include a variety of functions to support software developers, such as code editing automation, syntax highlighting, automated code completion, refactoring support, compilation, testing, debugging, documentation support, code review support, and the like.

As is set forth in greater detail below, exemplary embodiments of the present disclosure are generally directed to integrated development environment (IDE) assistance tools that provide persistent, context-aware recommendations across various interfaces and assistance features of the IDE, while also continuously learning and adapting to user preferences and patterns. The exemplary systems and methods provided by embodiments of the present disclosure utilize a multi-layer memory architecture that includes a short-term memory and a long-term memory. The short-term memory stores representations of recent interactions and contextual information associated with a user across multiple interactions for efficient retrieval, while the long-term memory stores patterns and preferences learned across multiple sessions (e.g., multiple sessions, multiple users, across an organization, etc.). The information stored in the short-term and long-term memories are managed and maintained based on various parameters (e.g., recency of information, frequency of use, confidence scores, rankings, etc.), conflict resolution, implicit and explicit feedback signals, and the like. Recommendations are retrieved from the multi-layer memory using a weighted relevance function that is continuously optimized based on interactions with the user.

In some embodiments of the present disclosure, a user's interactions with an IDE are processed and ingested into the multi-layer memory. For example, a user's interactions across multiple interfaces (e.g., chat, inline chat, inline, etc.) and with various assistance features (or agents) of the IDE are received and processed by a summarization engine to generate summaries of the interactions. The generated summaries are then processed by an embedding generator to generate embedding vectors that are representative of the summaries. The embedding vectors are indexed and stored, along with various contextual information (e.g., time, usage frequency, the relevant agent, etc.), in a short-term memory of the multi-layer memory to facilitate efficient retrieval across the various interfaces and features of the IDE.

In addition to the ingestion of user interactions into the short-term memory of the multi-layer memory, information stored in the short-term memory may be continuously reviewed to identify information that is to be transferred to a long-term memory of the multi-layer memory and information that is to be removed from the short-term memory. For example, a relevance of the information may be determined based on parameters such as usage frequency, recency, contextual relevance, etc. to identify user patterns and preferences to identify the information in the short-term memory that is to be transferred to the long-term memory. Additionally, as user interactions are incrementally ingested into the multi-layer memory, implementations of the present disclosure merge the newly ingested information with the information already stored in the multi-layer memory to maintain the relevancy of the stored information, resolve conflicts between the newly ingested information and the stored information, prevent redundancy of the information, and the like. This includes, for example, continuous refinement of the information based on user patterns, user preferences, user styles, best practices, development and/or evolution of the user, and the like, across the various interfaces and features of the IDE.

Additionally, exemplary embodiments of the present disclosure provide a machine learning agent that is trained to retrieve and return relevant information from the multi-layer memory. For example, a user interaction with the IDE may trigger a retrieval event, and the interaction may be provided as an input to a weighted relevance function to query and retrieve relevant contextual information from the multi-layer memory. The contextual information may be utilized by one or more assistance features (e.g., agents) of the IDE to generate and serve recommendations to the user. After such recommendations are served to the user, explicit signals and implicit signals may be extracted and/or inferred from subsequent user interactions to determine feedback scores for the served recommendations. Such explicit and implicit signals may be used to continuously update and/or train the machine learning agents and/or the relevance function.

Advantageously, the exemplary embodiments of the present disclosure address limitations of current IDE assistance tools and features by providing persistent, context-aware recommendations across various interfaces and assistance features of the IDE, while also continuously learning and adapting to user preferences and patterns. This can facilitate maintaining rich context across sessions, IDE interfaces, user, groups, teams, and organizations. Additionally, the continuous learning of the described systems and methods facilitate continuous adaptation to user patterns and patterns, as well as growth and evolution as developers. Further, while the examples discussed herein primarily describe the maintenance of a consistent provider network side representation of an IDE project, it will be appreciated that the disclosed implementations may likewise be used in any type of system or service where persistent and adaptable contextual information may be applied.

It will be appreciated that a software development service (“SDS”), as described herein in connection with exemplary embodiments of the present disclosure, can support a broad array of tasks, from small bug fixes to sweeping refactoring changes that impact multiple interdependent applications. For example, an SDS, which may include an IDE, can self-debug and fix errors, bugs, and vulnerabilities in a software program, transform code, perform refactoring, replace packages in code, etc. Specifically, the SDS can identify errors or potential errors, determine solutions to those errors, test those solutions to determine whether, when implemented, the solution generates additional errors in the code, or other problems, and then decide whether to commit the solution as part of a strategic process of achieving error-free code.

Further, in some implementations, an AI system, such as an LLM or other generative model, may be used to understand an application's architecture and the changes or possible solutions to provide assistance, resolve errors in the code, and/or to provide a contextually relevant response to a prompt. For example, the SDS may analyze a source code of an application that is to be debugged, transformed, etc., any documentation about the application, and information about the resources that comprise the application (ex: specific compute and storage resources) to understand the application code and architecture, for example by querying the application programming interfaces (“APIs”) of other services to gather information about the application's resources and configuration and provide a contextually relevant response to a query submitted by a developer.

To provide an example, a developer may describe a change such as ‘switch the frontend of my application's container cluster to application load balancer.’ The SDS, executing on the provider network, may determine a portion of the application's source code that is relevant to the developers input and generate an AI prompt that includes the developer input (the query), the determined relevant portion of the source code, and instructions for the AI system to generate a response to the prompt while considering the determined relevant portion of the source code included in the prompt. In the illustrated example, the response from the AI system may include a change to the provided relevant portion of the source code that changes the source code such that the frontend of the application container cluster is switched to an application load balancer and/or propose a list of next steps, such as ‘create a new application load balancer’, ‘configure round-robin load balancing across containers’, ‘test the load balancer with example traffic’, and ‘add an alarm for error messages from the cluster’, and include for each step the required command-line interface (“CLI”) commands, infrastructure-as-code, application code, and tests. In such examples, the developer is provided with contextually relevant responses to a query submitted by the developer.

Further, source code and documentation can be highly proprietary and so embodiments of the SDS discussed herein, as part of a provider network, will not use such content, whether developer provided or AI-generated for the developer, from one developer for purposes of assisting other developers, but rather keeps any source code, documentation, and/or learnings based on such materials (e.g., trainings, code completions, fine tuning of any of its models, etc.) within the boundaries of the owning developer's account. Embodiments of the SDS may also expose an application programming interface (“API”) that users/developers can use to fine-tune its AI systems for their use cases and provide additional runtime context. Accordingly, there may be many slightly different copies of the AI systems of the SDS, each tuned to support a specific developer or organization based on their proprietary code and documentation.

Accordingly, disclosed are methods, apparatus, systems, and non-transitory computer-readable storage media for enabling an advanced SDS. The SDS can assist with a variety of software development efforts, including for complex tasks that involve multi-step reasoning or require large amounts of user-specific context, by leveraging generative AI systems such as LLMs. Generative AI systems can create new data instances as output. A new data instance means that it is generated by the model based on the model parameters and is not carried over from the model input or otherwise copied from outside the model (for example, from an index of searchable content). Example data instances include producing AI-generated code recommendations, generating unit tests, generating documentation, supporting code reviews, and the like. The SDS acts as an intermediary between users and AI systems, enriching user prompts with additional instructions, context, and/or AI-generated code, monitoring AI system responses, and, in some cases, performing various “under-the-hood” interactions with the AI systems without requiring action by the user/developer.

In some examples, the SDS and/or IDE includes agent applications that formalize various software development effort workflows and their interactions with an AI system, such as an LLM. Agent applications serve as an intermediary between a user and an LLM, operating to expand user prompts, curate LLM responses, and provide the LLM with additional context often without user intervention. Additionally, various control mechanisms that regulate interactions with an LLM are introduced by way of example in the agent applications. Such control mechanisms can be used to avoid circular conversations with an LLM, keep the LLM on task, validate LLM responses, and the like.

“Embeddings,” “embedding vectors,” or “code construct embeddings” as used herein, are mathematical representations that capture the semantic meaning of text data, such as a code construct, enabling efficient search, retrieval, and/or comparison. These embeddings can be stored in a memory, such as within a code repository. As discussed herein, code construct embeddings may be used to efficiently search for and identify existing segments of code (code constructs) for various purposes including, but not limited to, retrieval augmented generation (“RAG”) search, structured code search, reference determination, refactoring candidates, migration candidates, etc.

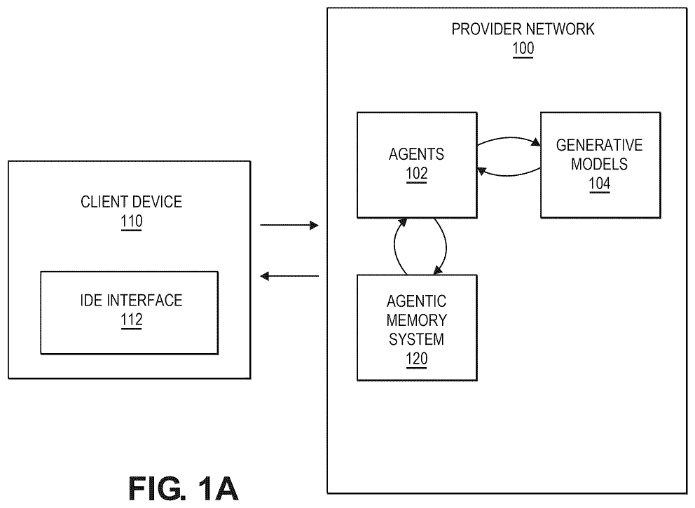

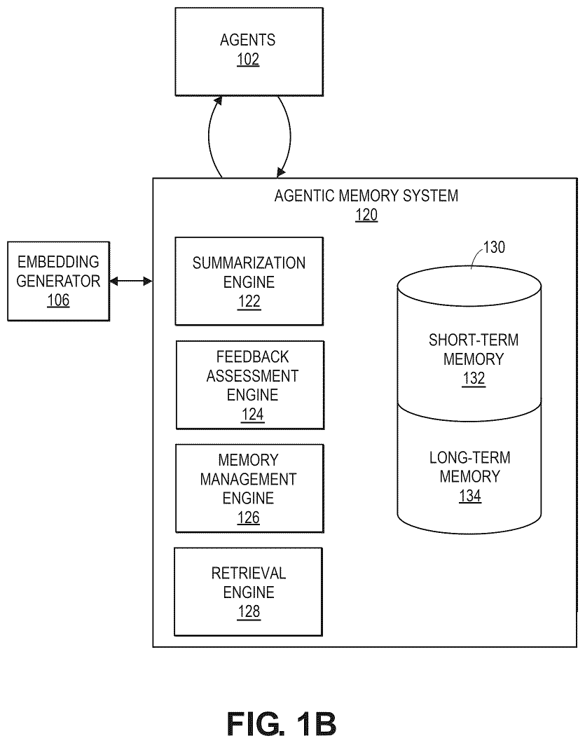

FIGS. 1A and 1B are logical block diagrams illustrating an exemplary agentic memory system 120, according to exemplary embodiments of the present disclosure. For example, agentic memory system 120 may be implemented in an IDE in connection with assistance tools and/or features provided by the IDE.

As shown in FIGS. 1A and 1B, client device 110 may communicate (e.g., via a communication network) with provider network 100 to access and execute various services and/or applications hosted by provider network 100, such as an IDE (e.g., cloud-based IDE, etc.). Client device 110 may include any type of computing device, such as a tablet, laptop computer, desktop computer, etc., and the communication network via which client device 110 and provider network 100 communicate may include any wired or wireless network (e.g., the Internet, cellular, satellite, Bluetooth, Wi-Fi, etc.) that can facilitate communications between client device 110 and provider network 100.

In the illustrated implementation, a user (e.g., developer) of client device 110 may access and/or execute an IDE hosted on provider network 100 via IDE interface 112. For example, a user may access IDE hosted on provider network 100 using client device 110 in connection with the creation, building, testing, etc. of software code. The IDE may provide various assistance tools and features to the developer in connection with the creation, building, testing, etc. of software code. The various assistance tools and features may be powered by one or more agents 102 that are configured to communicate with generative models 104 and agentic memory system 120 in providing assistance to users of the IDE. Generative models 104 may include a generative language model, such as a large language model (LLM), and agentic memory system 120 may include a multi-layer memory that stores short-term and long term preferences, patterns, and other contextual information. For example, agentic memory system 120 may store preferences and patterns such as coding style preferences, error handling patterns, code review patterns, code documentation preferences, framework preferences, unit test preferences, and the like. In providing assistance to users of the IDE, agents 102 may generate natural language prompts based on interactions with the developer using the IDE. The generated prompts may be augmented with contextual information that is obtained from agentic memory system 120 and provided to generative models 104. Generative models 104 process the prompts and return recommendations to be served to the user of the IDE. According to aspects of the present disclosure, agents 102 may be configured to generate real-time code suggestions, automate the upgrading and transformation of code, generate documentation for code, generate unit tests, support code reviews by identifying potential issues and suggested fixes, and the like.

As may be understood, generative models such as LLMs are generally understood to be probabilistic models designed to generate and understand natural language. Often, LLMs employ a transformer type neural network that include millions or even billions of model parameters and are typically trained using large datasets of documents. Generative models are often trained on a large corpus of data for a specific task. In connection with providing IDE assistance tools, generative models 104 is trained on a corpus of software code, software code documentation, code testing, and the like. Exemplary LLMs include Amazon's Titan, Anthropic's Claude 3.5 Sonnet, GPT, etc.

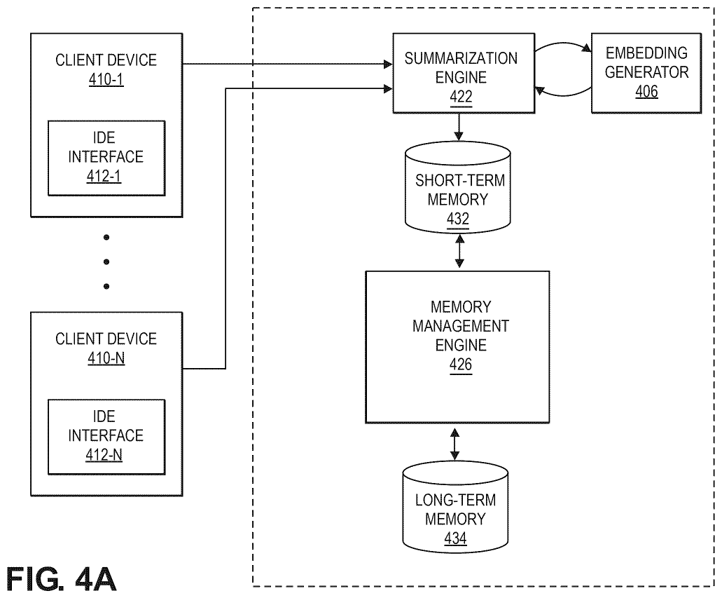

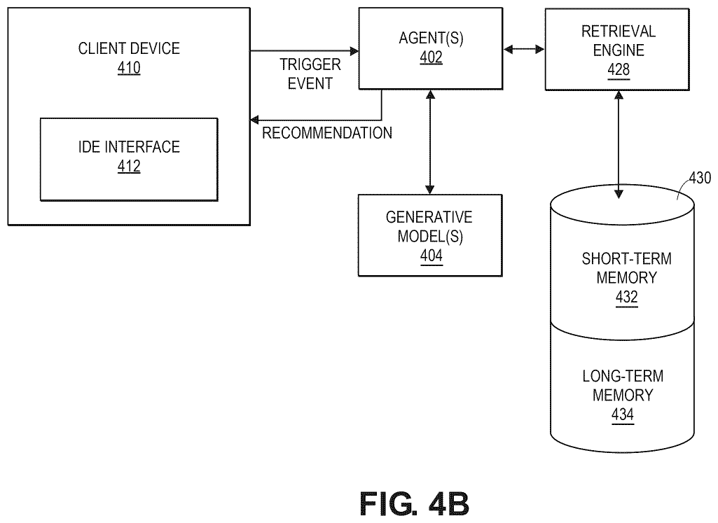

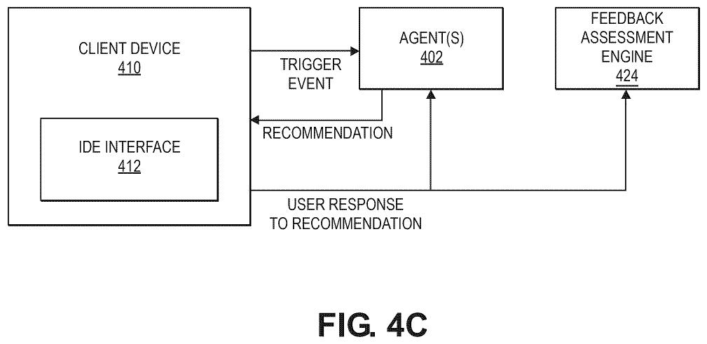

As illustrated in FIG. 1B, agentic memory system 120 is configured to ingest, process, and store user interactions with an IDE hosted by provider network 100 and includes summarization engine 122, feedback assessment engine 124, memory management engine 126, retrieval engine 128, and one or more multi-layer memory 130, which includes short-term memory 132 and long-term memory 134. Short-term memory 132 is preferably configured to store recent preferences, patterns, contextual information, and/or best practice information associated with a current and/or particular session, a particular user/project group/team, etc., while long-term memory 134 is preferably configured to store preferences, patterns, contextual information, and/or best practice information aggregated over multiple sessions, multiple users, across an organization, and the like. Summarization engine 122 is configured to generate summaries of user interactions with the IDE for ingesting information into multi-layer memory 130, feedback assessment engine 124 is configured to determine feedback scores for stored information based on user interactions with the IDE, memory management engine 126 is configured to manage the information stored in multi-layer memory 130, and retrieval engine 128 is configured to identify and return relevant information from multi-layer memory 130 in response to a triggering event. The various aspects and components of agentic memory system 120 are described in further detail below and in connection with at least FIGS. 4A-4C.

In exemplary implementations, user interactions with the IDE (e.g., across different IDE interfaces and features) are received by agentic memory system 120 and processed by summarization engine 122. The user interactions received by agentic memory system 120 may include all interactions with the IDE, such as writing code, writing documentation, queries submitted via a chat interface, adoption/rejection of recommendations, and the like. Summarization engine 122 preferably includes one or more trained machine learning models (e.g. BERT model, LLMs, encoder-decoder models, specialized models, etc.) that employ extractive and/or abstractive summarization techniques to extract relevant elements (e.g., code snippets, error messages, etc.) and identify patterns and preferences from the user interactions to condense the user interactions for efficient storage. The summaries generated by summarization engine 122 is processed by embedding generator 106 to generate multi-dimensional embedding vectors that semantically represent the generated summaries. The embedding vectors are then indexed and stored in short-term memory 132, along with metadata such as a timestamp, usage frequency information, feedback score, identification of an associated agent, and the like, as short-term contextual information associated with the user of the IDE. Preferably, short-term memory 132 may be implemented as a retrieval augmented generation (RAG) system. Accordingly, the short-term contextual information stored in short-term memory 132 can correspond to contextual information, preferences, and/or patterns for a particular coding session of a user. Alternatively and/or in addition, the short-term contextual information stored in short-term memory 132 can correspond to contextual information, preferences, patterns, and/or best practices information associated with an on-going project, a project team, and the like.

In addition to the ingestion of information into short-term memory 132, agentic memory system 120 includes memory management engine 126, which may include one or more trained machine learning models, probabilistic models, rule-based models, heuristic models, and the like that are configured to manage information stored in short-term memory 132, information stored in long-term memory 134, and the transfer of information between short-term memory 132 and long-term memory 134. Memory management engine 126 provides a learning pipeline that facilitates merging new information ingested into multi-layer memory 130, while also managing information stored in short-term memory 132 and long-term memory 134. For example, memory management engine 126 may be configured to periodically process information stored in short-term memory 132 to identify information that is to be transferred to long-term memory 134 and/or information that is to be discarded from short-term memory 132. Optionally, memory management engine 126 may also be configured to mark and/or tag certain information as information that may potentially be deleted/discarded (e.g., may be deleted and/or discarded in the near future, candidate for future deletion, or candidate for future transition to long-term memory). According to aspects of the present disclosure, memory management engine 126 may generate summaries of information stored in short-term memory 132 to identify preferences and patterns across an aggregation of information in multiple dimensions (e.g., coding style, documentation preferences, error handling preferences, testing preferences, code review preferences, coding architecture/framework preferences, etc.) to determine a relevancy of the information. For example, memory management engine 126 may consider parameters associated with the information such as a recency of the information, a usage frequency of the information, a feedback score associated with the information, a contextual relevance of the information, and the like. Information having a relevance score above a first threshold value (or eventually reached the relevance score above a first threshold) may be transferred from short-term memory 132 to long-term memory 134. Alternatively and/or in addition, information having a relevance score below a second threshold value may be discarded. Information having a relevance score between the first and second thresholds may be designated for continue observation. As certain information moves up in score (e.g., frequency of use increased) that information may be marked and/or tagged as a potential candidate for long-term memory 134. As certain information moves down in score (e.g., contextual relevance is reducing over time), that information may potentially be tagged or labeled for moving below the second threshold value after a period of time.

Additionally, as new information is ingested into multi-layer memory 130, memory management engine 126 may determine how the newly ingested information relates to information already stored in long-term memory 134. For example, it may be determined whether the new information is consistent with patterns and preferences stored in long-term memory 134, is redundant in view of information stored in long-term memory 134, conflicts with information stored in long-term memory 134, and the like. In exemplary implementations, relevance scores and/or weightings may be determined for information stored in long-term memory 134. The relevance scores/weightings may be determined based on various parameters, such as a time decay function (e.g., linear, exponential, Gaussian, logarithmic, logistic, etc.), feedback scores, usage frequency, contextual relevance, and the like. The relevance scores/weightings may be used to determine information that is to be discarded from long-term memory 134 (e.g., relevance score/weighting falls below a threshold value, etc.), determine how newly ingested information is handled in the event that a conflict is identified, determine information that is to be potentially discarded and/or deleted from long-term memory 134 (e.g., relevance score/weighting below a first threshold value and above a second threshold value, etc.), and the like. Accordingly, long-term memory 134 builds comprehensive user profiles that include preferences, patterns, best practices information, and the like, across multiple dimensions, interfaces, and features that are aggregated across multiple coding sessions of the user.

As illustrated in FIG. 1B, agentic memory system 120 may also include retrieval engine 128. Retrieval engine 128 may include a machine learning agent trained to identify, retrieve, and return relevant information from multi-layer memory 130 in view of a triggering event. For example, as a user interacts with the IDE hosted by provider network 100, certain interactions may cause one or more of agents 102 to request relevant contextual, preference, pattern, best practices, etc. information stored in multi-layer memory 130. Triggering interactions may include queries entered into a chat interface, inline queries, inline text that causes one or more agents 102 to determine to serve a recommendation (e.g., suggested code, etc.), and the like. In response to the triggering event, the interaction may be used as an input to determine relevant information from multi-layer memory 130. For example, the interaction may be summarized (e.g., by one or more of agents 102 and/or summarization engine 122), processed to generate an embedding vector that represents the semantic meaning of the interaction (e.g., by embedding generator 106), and processed using a weighted relevance function to identify and return relevant information stored in multi-layer memory 130. In an exemplary implementation, the weighted relevance function may be represented as:

$$\begin{matrix}Relevance ( i ) = α * semantic\_similarity ( input , i ) + \\ β * temporal\_recency ( i ) + \\ γ * usage\_frequency ( i ) + \\ δ * feedback\_score ( i ) + \\ ε * interface\_alignment ( input\_interface , i\_interface )\end{matrix}$$

where i represents the information stored in multi-layer memory 130, input represents the triggering interaction, i_interface represents the feature and/or agent associated with the information stored in multi-layer memory 130, input_interface represents the feature and/or agent associated with the triggering interaction, semantic_similarity represents an embedding similarity between the two terms, temporal_recency represents a time-decay function, usage_frequency represents a frequency at which the information is accessed, feedback_score indicates a feedback score determined based on explicit and implicit signals determined from user interactions, and interface_alignment represents a measure of the correspondence of the associated features and/or agents, and (α, β, γ, δ, ε) represent weights that are continuously optimized in view of subsequent user actions, feedback scores, and the like. Accordingly, the N number of preferences, patterns, contextual information, best practices information, etc. stored in multi-layer memory 130 having the highest relevance scores may be retrieved and returned in response to the triggering event. Alternatively and/or in addition, the preferences, patterns, contextual information, best practices information, etc. stored in multi-layer memory 130 having relevance scores above a threshold value may be retrieved and returned in response to the triggering event. Accordingly, agents 102 can utilize the retrieved user preferences, patterns, contextual information, best practices information, etc. in generating and serving a recommendation or suggestion in response to the trigger event. For example, the retrieved user preferences, patterns, contextual information, best practices information may be incorporated into a prompt to a LLM so that the generated recommendation or suggestion adopts the user preferences, patterns, contextual information, best practices information in the generated recommendation or suggestion. This can include preferences, patterns, and best practices information in connection with a level of expertise of the user (e.g., more detailed suggestions and more simplistic code suggestion vs. less detail and more complex code suggestions), the structure of code, a coding style, a communication style, the content of documentation, the testing of code, the error handling in code, the handling of code reviews, the commenting in code, and the like.

As illustrated in FIG. 1B, agentic memory system 120 may also include feedback assessment engine 124. Feedback assessment engine 124 may include one or more trained machine learning models (e.g. BERT model, LLMs, trained classifier, etc.) that are configured to process and determine the effectiveness of the retrievals based on user interactions. For example, user interactions with the IDE after recommendations have been served to the user may be ingested and processed by feedback assessment engine 124 to determine the effectiveness of the retrieved information that was used in serving the recommendations to the user. For example, the user interactions may be processed to determine whether they are explicit or implicit signals. Explicit signals may include indicators such as acceptance and/or adoption of served suggestions, refusal of served suggestions, modification of served suggestions, express feedback mechanisms (e.g., thumbs up/down), and the like, while implicit signals may be inferred from user interactions to determine satisfaction with the served recommendations. User interactions such as reformulation of queries, repetition of queries or interactions, engagement time with responses, interactions across interfaces and/or features, and the like may be considered in inferring implicit signals. Optionally, confidence scores may also be determined in connection with the inferred implicit signals, and any implicit signals having a confidence score below a threshold value may be discarded. The explicit and implicit signals may be used to, for example, determine feedback scores, continuously optimize retrieval engine 128, and the like.

In operation, when a developer interacts with the IDE hosted by provider network 100, an identifier associated with the developer may be used to identify and retrieve long-term information, such as user personal preferences, patterns, best practices information, and the like, stored in long-term memory 134. Additionally, the identifier may include an indication of development/project teams, organizations, groups, etc. that the developer is a member of, and preferences, patterns, best practices information, and the like associated with the development/project teams, organizations, groups, etc. may also be identified and retrieved. According to certain aspects of the present disclosure, different preferences, patterns, best practices information, and the like may be retrieved based on the project the developer is working on, different interfaces and/or features of the IDE accessed by the developer, programming language being used, and the like. For example, agentic memory system 130 may identify and retrieve a first set of preferences, patterns, and/or best practices information for a first project the developer is working on, while loading a second set of preferences, patterns, and/or best practices information for a second project the developer is working on. Alternatively and/or in addition, a first set of preferences, patterns, and/or best practices information may be identified and retrieved for use when the developer is accessing a documentation agent, while a second set of preferences, patterns, and/or best practices information may be identified and retrieved for use when the developer is accessing a test agent.

After the relevant preferences, patterns, best practices information, and the like have been retrieved, the developer's interactions (e.g., via inline text, inline queries, a chat interface, etc.) with the IDE may be processed and ingested by agentic memory system 130 as short-term preferences, patterns, contextual information, best practices information, and the like. For example, the developer's interactions may be summarized by summarization engine 122 and processed by embedding generator 106 to generate embedding vectors that are indexed and stored in short term memory 132, along with metadata such as a timestamp, usage frequency information, feedback score, identification of an associated agent, identification of an associated interface, and the like. Additionally, the developer's interactions with the IDE may form a triggering event, such that one or more of agents 102 request relevant contextual, preference, pattern, and/or best practices information stored in multi-layer memory 130. The interaction may be processed by agentic memory system 120 to identify relevant information stored in multi-layer memory 130, and return the identified information to the requesting agent. The agent may use the relevant information to generate a prompt for generative models 104 to serve a recommendation (e.g., code suggestion, suggested documentation for code, suggested unit tests, code reviews by suggestions, etc.) to the developer. The developer's response to the recommendation may also be processed by agentic memory system 120 for storage in short-term memory 132 and/or determination of feedback information and/or scores associated with the interactions. Accordingly, the developer's continued interactions with the IDE are continuously processed and ingested by agentic memory system 120 to identify items that are to be transferred to long-term memory 134, and to continuously update and optimize the retrieval of relevant information. In some aspect of the present disclosure, short-term and long-term memory (132 and 134 respectively) are referred to as different memory spaces. The multi-layer memory 130 may be a single memory device partitioned into two or more memory spaces (e.g., similar to that of a disk drive partitioning). The multi-layer memory 130 may also be represented as interconnected memory devices where one or more of the memory devices are programmed as short-term memory space and one or more of the memory devices are programmed as long-term memory space.

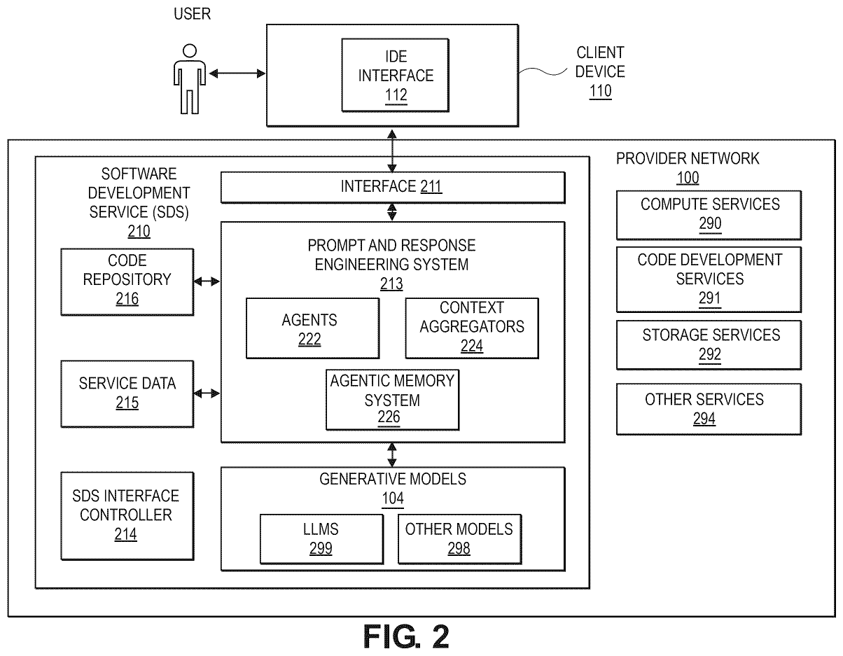

FIG. 2 is a block diagram illustrating a high level overview of an exemplary SDS 210 and environment, according to exemplary embodiments of the present disclosure.

As shown in FIG. 2, an SDS 210 acts as an intermediary that interfaces with generative models 104, such as language models, on behalf of clients. Language models probabilistically generate natural language (e.g., the word “said” is more likely to appear after the word “he” than after the word “dolphin”). As an intermediary, the SDS 210 can manage client interactions with generative models. For example, the SDS 210 can receive prompts before submitting them to an LLM and can curate LLM responses. Expanding prompts can provide the LLM with additional information relevant to a particular task, including by adding additional context about the nature of the prompt and by adding context-specific details. For example, as discussed further below, an LLM prompt relating to recommendations and suggestions to be served by an agent application may be expanded to include user preference information, user pattern information, other contextual information, best practices information, and the like.

With prompt expansion, the SDS 210 can improve the quality of LLM responses. For example, when a developer is writing code, the SDS 210 may tokenize the code inputs, for example by producing a token for each word input by the developer and/or combining one or more tokens to produce a prompt to an LLM 299 requesting that the LLM produce a predicted next token(s) that is predicted to be a next piece of code in the code development by the developer. Prompt expansion may include providing user preference information, user pattern information, other contextual information, best practices information, and the like as part of the prompt to guide the LLM 299 in producing the predicted next token(s), thereby increasing the accuracy in the AI system.

One common environment for an SDS 210 is a provider network 100. A provider network 100 (or, “cloud” provider network) provides users with the ability to use one or more of a variety of types of computing-related resources such as compute resources (e.g., executing virtual machine (“VM”) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (“CDNs”), Domain Name Service (“DNS”)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of provider networks 120 can use one or more user accounts that are associated with a customer account, though these terms can be used somewhat interchangeably depending upon the context of use. The users can interact with a provider network 100 via one or more interface(s), such as through use of API calls, via a console implemented as a website or application, through a development environment interface 112, and the like.

An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another.

For example, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

Cloud provider networks often provide access to computing resources via a defined set of regions, availability zones, and/or other defined physical locations where a cloud provider network clusters data centers. In many cases, each region represents a geographic area (e.g., a U.S. East region, a U.S. West region, an Asia Pacific region, and the like) that is physically separate from other regions, where each region can include two or more availability zones connected to one another via a private high-speed network, e.g., a fiber communication connection. An availability zone (also known as an availability domain, or simply a “zone”) refers to an isolated failure domain including one or more data center facilities with separate power, separate networking, and separate cooling from those in another availability zone. Preferably, availability zones within a region are positioned far enough away from one another that the same natural disaster should not take more than one availability zone offline at the same time, but close enough together to meet a latency requirement for intra-region communications. The data centers house physical computing devices (e.g., suitable types of servers) that host the bare metal and virtualized resources (e.g., compute, networking, & storage) on which cloud services and customer workloads run.

Furthermore, regions of a cloud provider network are connected to a global “backbone” network which includes private networking infrastructure (e.g., fiber connections controlled by the cloud provider) connecting each region to at least one other region. This infrastructure design enables users of a cloud provider network to design their applications to run in multiple physical availability zones and/or multiple regions to achieve greater fault-tolerance and availability. For example, because the various regions and physical availability zones of a cloud provider network are connected to each other with fast, low-latency networking, users can architect applications that automatically failover between regions and physical availability zones with minimal or no interruption to users of the applications should an outage or impairment occur in any particular region.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network 100 may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity-such as the provider network itself-that can be executed on demand. Serverless functions can be maintained within the provider network 100 by an on-demand code execution service and can be associated with a particular user or account or can be generally accessible to multiple users/accounts. A serverless function can be associated with a Uniform Resource Locator (“URL”), Uniform Resource Identifier (“URI”), or other reference, which can be used to invoke the serverless function. A serverless function can be executed by a compute resource, such as a virtual machine, container, etc., when triggered or invoked. In some examples, a serverless function can be invoked through an API call or a specially formatted HyperText Transport Protocol (“HTTP”) request message. Accordingly, users can define serverless functions that can be executed on demand, without requiring the user to maintain dedicated infrastructure to execute the serverless function. Instead, the serverless functions can be executed on demand using resources maintained by the provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of provider network 100 to provision and manage compute resources such as virtual machine instances. Virtual machine technology can use one physical server to run the equivalent of many servers (each of which is called a virtual machine), for example using a hypervisor, which can run at least partly on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

A virtual private cloud (“VPC”) (also referred to as a virtual network (“VNet”), virtual private network, or virtual cloud network, in various implementations) is a custom-defined, virtual network within another network, such as a cloud provider network. A VPC can be defined by at least its address space, internal structure (e.g., the computing resources that comprise the VPC, security groups), and transit paths, and is logically isolated from other virtual networks in the cloud. A VPC can span all of the availability zones in a particular region.

A VPC can provide the foundational network layer for a cloud service, for example a compute cloud or an edge cloud, or for a customer application or workload that runs on the cloud. A VPC can be dedicated to a particular customer account (or set of related customer accounts, such as different customer accounts belonging to the same business organization). Customers can launch resources, such as compute instances, into their VPC(s). When creating a VPC, a customer can specify a range of IP addresses for the VPC in the form of a Classless Inter-Domain Routing (CIDR) block. After creating a VPC, a customer can add one or more subnets in each availability zone or edge location associated with its region.

SDS 210 can assist users with various software development tasks. Example software development tasks include development of software project plans, subdividing a software development task into steps, troubleshooting software errors, transforming code from an old or out of date version to a current version of the code (e.g., Java 8 to Java 17), transforming code from one language or platform to another (e.g., . net to Linux), producing AI-generated code for the user, referred to herein as syntactically complete code completion suggestions or syntactically complete code completions, etc. Strung end-to-end, these tasks can represent a large portion of an overall software development effort, from planning to implementation and troubleshooting. Note that as used herein, a software system can refer to an individual program or to a collection of programs, context about the program(s) such as their operating environment and/or structure on which they are executed or distributed (e.g., cloud-level resources), mappings of communications or data flows between the programs (if applicable), etc. In some examples, such a software system may be implemented through an IDE that is accessible to the user via IDE interface 112.

As illustrated, the SDS 210 includes an interface 211, a prompt and response engineering system 213 that includes agents 222, agentic memory system 226, and context aggregators 224, service data 215, and LLMs 299. Interface 211, typically an API, provides different entry points for clients to interact, via the SDS 210, with an LLM 299 and/or other generative models 104, such as other models 298. A user interacts with an SDS 210 via client device 110. Client device 110 can display IDE interface 112. IDE interface 112 send and receive data via the interface 211 of the SDS 210. IDE interface 112 can include a chat interface, which can be part of a graphical user interface providing a “chat” type interface commonly associated with LLMs in which users can type text and receive responses.

IDE interface 112 may communicate through interface 211 and provide IDE projects to the user so the user can develop code, make modifications to their software, etc. Interface 211 can also provide a more programmatic entry point for other applications or services such as an issue management service (also sometimes referred to as issue tracking service), a logging service of the provider network, or the application displaying the IDE interface 112 (e.g., an IDE or issue management application executed by the client device 110). API calls via these type entry points can include, like the chat-based interface, free-form text (e.g., bug descriptions or change requests from an issue tracking system, error messages from the logging service, IDE project snapshots, transaction logs indicating changes to an IDE project, etc.) but further include additional contextual parameters available to the application or application environment issuing the call (e.g., an identification of the code repository associated with a particular software change request, an identification of the cloud-hosted instance generating a log entry, etc.).

Generally speaking, the SDS interface 211 can provide for interactions with various clients, including human users such as the user via IDE interface 112, and with other applications such as software development environments, software management systems, issue tracking systems, etc. These application-based clients typically interact with the SDS API via calls having a more structured set of parameters (e.g., accepting a structured format file that includes identifications of various data sources) as compared to the freeform text found in calls from a chat-based interface, for example.

SDS 210 can support multi-tenancy, allowing multiple clients to connect and interact with LLMs 299. Each client can have one or more sessions with SDS 210, the sessions corresponding to sessions with an LLM 299 and/or other services of SDS 210, such as an IDE service. To do so, SDS 210 can track, for a given session, the last N prompts sent to, and responses received from, the LLM in a memory such as in service data 215. The memory can be implemented as a moving window or circular buffer: as new prompts are sent and responses received, SDS 210 deletes or overwrites the oldest entries. For a given session, the prompt and response engineering system 213 may embed all or a portion of the session memory in prompts submitted to the LLM by any of the agents 222. For example, if a session includes session history X and a new prompt P, the prompt and response engineering system 213 can concatenate P to X or to the most M most recent prompts and responses (where M<N) and submit the result of the concatenation to the LLM.

SDS 210 can assign a session identifier to new sessions, allowing clients to pause and resume sessions. By referencing a session identifier upon connecting to the SDS 210, a client can return to an existing session. SDS 210 can permit access to sessions based on a permissions policy associated with a principal account credential provided in establishing a connection to connect to SDS 210. The credential may be associated with a user or group of an organization. The permissions policy can permit sharing of a session across different entities within the organization. For example, a first client may initiate a first session with SDS 210 and receive a session identifier X. Later, a second client may resume the first session with SDS 210 by providing the session identifier X, provided the credential provided when the second client established the connection to SDS 210 is permitted to do so.

The prompt and response engineering system 213 can also monitor client text inputs over a session for certain session-management instructions. Such session-management instructions can be associated with various session-level operations. One example session-level operation is SESSION_RESET to reset a session, clear the memory associated with that session, and reset the associated session(s) with LLMs 299. Another example session-level operation is SESSION_CLOSE to close a session with SDS 210 and any associated session(s) with LLMs 299.

The prompt and response engineering system 213 includes agents 222, agentic memory system 226, and context aggregators 224. In some embodiments, Agents 222 include various task-specific agents as well as other general agents that support SDS interactions with LLM 299. Task-specific agents formalize various software development effort workflows, operating to expand user prompts, curate LLM responses, and provide the LLM with additional context often without user intervention. Agentic memory system 226 can provide short-term and long-term user preference information, user style information, user pattern information, best practices information, and the like to assist agents 222 to generate and/or expand prompts provided to LLMs in connection with generating and serving recommendations and suggestions. Context aggregators 224 retrieve additional data that agents can use to expand prompts or to otherwise provide to an LLM as conversation context to improve the relevance of LLM responses. Context aggregators 224 can retrieve the additional data from other cloud-based services, such as compute services 290, storage services 292, other services 294, etc.

SDS 210 may implement (or have access to) code repositories 216. Code repositories 216 may store various code files, objects, embeddings, and/or other code that may be interacted with by various other features of the SDS 210 (e.g., the IDE to write, build, compile, and/or test code). Code repositories 216 may implement various version and/or other access controls to track and/or maintain consistent versions of collections of code for various development projects, in some implementations. In some implementations, code repositories 216 may be stored or implemented external to provider network 100 (e.g., hosted in private networks or other locations). Service data 215 can include data such as prompt templates, response definitions, user preferences, session state data, etc.

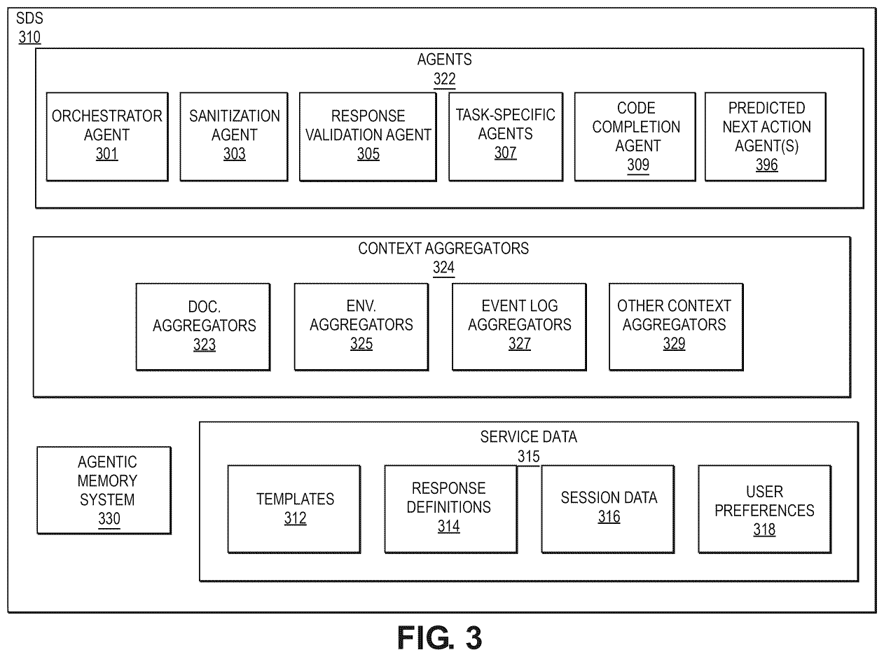

FIG. 3 is a block diagram that illustrates additional details of a software development service (“SDS”) 310, according to exemplary embodiments of the present disclosure.

As shown in FIG. 3, agents 322 include various task-specific agents 307 as well as other general agents that support SDS interactions with an LLM 299. Example general agents include an orchestrator agent 301 that can manage a session with a client, a sanitization agent 303 that can ensure prompts and responses are within the scope of various tasks or do not venture into sensitive or objectionable material, a response validation agent 305 that can evaluate LLM responses against expected results, and a code completion agent 309 that interfaces with an IDE and an AI system to generate and return code completions suggestions.

In some examples, the orchestrator agent 301 can be the default agent executed upon connection by an application to the SDS 310 with a chat-based interface. Depending on the initial user prompt, the orchestrator agent 301 can identify the task requested to be performed and invoke the associated task-specific agent 307. The orchestrator agent 301 leverages an LLM 299 to determine whether a given prompt falls within a supported set of tasks and to identify which task-specific agent 307 should be invoked.

In some examples, the sanitization agent 303 reduces the likelihood of the LLM 299 providing objectionable or off-topic responses. Such responses may be artifacts of the LLM operations. Having received a response, a sanitization agent 303 can prompt the LLM 299 (or another LLM, or another instance of the LLM without a saved context) with questions related to the nature of the response, such as to test whether the response contains objectionable material, whether the response is related to the expected field of use (e.g., software development, error resolutions, etc.).

In some examples, the response validation agent 305 (or “validation agent”) verifies that an LLM response conforms with the response definition of the preceding prompt. The response validation agent can perform a variety of validations. Example validations include prompting the LLM (or another LLM, or another instance of the LLM without a saved context) with a question as to whether the received response conforms with the response definition of the previous prompt, testing whether the downstream software that processes the response can successfully parse it (e.g., parsing the response in a try-catch statement), etc.

Example task-specific agents 307 include agents that assist clients with a given task. For example, a system design agent can assist a client in gathering additional information to provide to the LLM to improve the LLM's response to a software development task (e.g., syntactically complete code completion generation), a development task agent can assist a client dividing a development task into sub-tasks or actions. An error resolution agent may automatically debug and resolve errors on behalf of the user and/or determine an efficient resolution to eliminate errors and provide guidance to the user. In some examples, requests that invoke a particular task-specific agent 307 without relying on the orchestrator agent 301 may be supported. For example, one API call can invoke the system design agent, another can invoke the development task agent, and another can invoke the error resolution agent.

Context aggregators 324 gather context about a given software system's environment to be provided to an LLM as part of the prompt expansion/creation operations of the SDS 310. Such additional data can range from general documentation applicable to a prompt to specific source code associated with a given component of the software system. Agents 322 can invoke context aggregators, in some cases depending on a previous response from an LLM identifying which additional context would assist it in generating a response. Using the information obtained from the invoked context aggregator(s), agents 322 can provide at least some of that information as additional context in subsequent prompts sent to the LLM.

Some context aggregators 324 can retrieve information from other cloud-hosted services of a provider network or other reachable sources (e.g., sources with public facing APIs external to the provider network). One example of such information is source code and configuration data, which can provide relevant context to an LLM. Another service of the provider network 100 may be a code repository service that stores source code, documentation, and other configuration data in repositories for various client applications.

In some examples, context aggregators 324 retrieve information about a particular software system. Such may be the case when a client of SDS 310 has engaged it for a task associated with an existing system. The client can provide references to the various cloud-hosted services that include details about the system to SDS 310, and the context aggregators 324 can retrieve that data. In other examples, context aggregators 324 retrieve information about other software systems owned by or otherwise accessible to a principal—typically the identity that was used to authenticate a client. The principal may be a user, group of users, organizational unit within a business, etc. SDS 310 can leverage context aggregators 324 to retrieve details about the other systems of the principal.

Often environmental parameters can have an effect on software program operations. Such environmental parameters can extend from the particulars of the operating system environment variables in which the application is running to the overall cloud-based environment, the latter particularly so when the application is hosted in a provider network. For example, another service of the provider network 100 may be a permissions service (e.g., an identity and access management service). Such a permissions service can include policies that define the various actions that principals can take or that various actions that can be taken upon hosted resources, thus impacting application execution. An environment aggregator 325 can access the permissions service to obtain permissions data associated with an identified software program.

Logged events and/or errors can also provide context regarding a development task, particularly when troubleshooting bugs or other errors. Another service 294 of the provider network 100 may be a logging service in which events, errors, and other types of activity related to applications executing in the cloud are recorded. An event log aggregator 327 can access the logging service to obtain logs associated with an identified software system.

General documentation related to a service or API can also provide useful context without being specifically associated with a particular application or user. Other types of more specific documentation can also be helpful. Such documentation can include software project descriptions, software documentation, source code files, ticketing systems, and the like from other public software programs or systems. Another service 294 of the provider network 100 may be a documentation service that stores such documentation. A documentation aggregator 323 can use Retrieval Augmented Generation (“RAG”) techniques to identify documents of “relevance” to a given task. Initially, each of the available documents, or portions thereof, with the documentation service can be encoded as an embedding, those embeddings stored in a database. When invoked, the documentation aggregator 323 can use the encoder to generate an embedding from user text for the given task. The documentation aggregator 323 can then identify relevant documents based on the distance between the task embedding and document embeddings in the database, selecting the N nearest document embeddings, document embeddings within some distance threshold, or some other criteria to identify documents having embeddings in proximity to the task embedding. The documentation aggregator 323 can then access the documentation service to obtain the documents associated with those selected embeddings.

Other context aggregators 329 may generate annotated context from data obtained by other context aggregators. For example, some context aggregators can compile and annotate data retrieved by other aggregators into a summary. Such a context aggregator can indicate, for each of the other context aggregators that retrieved data or other information, a description of the source of the information. As another example, some context aggregators may generate structural summaries of a software system. Cloud-hosted software systems are often structured as a collection of interacting services with user code running on various resources to coordinate those interactions. A system map (or “architectural map” or just “map”) can describe the structure of a software system. The structure can include details like programs, the cloud-level infrastructure or resources on which those programs are executed, the interconnection of those programs through various data transfers (e.g., API calls, passing JSON objects, etc.), environmental configuration data (e.g., environment variables available to the programs, variables that configure the resources on which programs execute, etc.), network-level configuration data (e.g., VPC configuration data, configuration data of virtual network components like routers or gateways, etc.). In some examples, a system map of the structure of a software system may have been previously defined (e.g., by the developer). In other examples, a system map context aggregator can generate a system map that provides a description of the software system.

Service data 315 can include templates 312, response definitions 314, session data 316, and user preferences 318. Templates 312 can include templates that provide additional text cues beyond what might otherwise be provided by a user. For example, a user might provide a prompt such as “generate code to perform task X.” A prompt template can encapsulate the user's prompt with various cues that improve the quality of the response of the LLM. One pattern used by agents associated with various tasks described herein is a template to prompt the LLM to ask questions (e.g., “You will be asked to respond to the following prompt: ‘generate code to perform task X.’ What information would assist you in your response?”). Prompt templates can be used to expand prompts received from various clients (a human user typing a software error into an issue tracking system that later submits an API call to SDS 310 is likely to use the same abbreviated language as a human user typing an error into a chat session with an LLM). Templates 312 can also include response templates for responses to be sent to clients, populated with data received from the LLM and/or actions taken by SDS 310 (e.g., generation of code).

Response definitions 314 define how SDS 310 will expect the response from the LLM to be formatted. Response definitions 314 can be used to structure or formalize the responses from LLMs to improve the ability of SDS 310 to parse those responses such that they can be stored, trigger follow on actions, etc. Example response definitions include instructing the LLM to respond in natural language forms such as with a Yes or No, a list of items, an enumerated list of items, etc., and also to respond with more structured forms (e.g., with Python code, with an SQL query, with a JSON object, etc.). Note that the interpretation of responses pursuant to response definitions is typically contingent on the phrasing of a prompt, tailored within a given agent (e.g., a negative response might indicate a pass for one prompt, a failure for another).

Session data 316 can include the historical dialogue with an LLM, as mediated by SDS 310. Not all prompts that SDS 310 submits to LLM 299 originate from a client, nor does SDS 310 send all responses from LLM 299 to the client. For this reason, the session data can include metadata about LLM interactions (e.g., whether a prompt originated from SDS 310 or a client, whether a response from the LLM was sent to a client). For example, while a client may submit a prompt of “can you generate code to perform function X,” the SDS may send a prompt to the LLM of “please provide one or more potential code components that when executed will perform function X.”

User preferences 318 can include stored user preferences based on prior dialogs with a client. In particular, the system design agent can elicit information from the client regarding preferences. Such preferences can include things such as preferred programming language (e.g., to instruct the LLM when requesting syntactically complete code completions), preferred compute options for cloud-hosted applications (e.g., whether a virtual machine, container, serverless function, etc.), permissions preferences (e.g., whether a certain set of principals can access the application), etc.

While not shown, service data 315 can include other data such as the types of tasks SDS 310 can support (typically those associated with the available task-specific agents) as well as the types of additional information or context that can be gathered (typically associated with the available context aggregators).

In exemplary implementations, agentic memory system 330 includes a multi-layer memory that stores short-term and long term preferences, patterns, best practices information, and other contextual information. The short-term and long term preferences, patterns, best practices information, and other contextual information stored by agentic memory system 330 may be used by one or more agents 322 in generating and serving recommendations, suggestions, and the like to clients, so that the recommendations and suggestions correspond to the user's style, preferences, and established best practices. Multi-layer agentic memory system 330 is described in further detail herein in connection with at least FIGS. 4A-4C and 5-9.

FIGS. 4A-4C are block diagrams of at least portions of an exemplary agentic memory system, according to exemplary embodiments of the present disclosure. FIG. 4A illustrates the ingestion and management of information stored by the agentic memory system, FIG. 4B illustrates the retrieval of relevant information stored by agentic memory system, and FIG. 4C illustrates a feedback loop for the agentic memory system.

As shown in FIG. 4A, client devices 410 (e.g., client device 410-1 and client device 410-N) may access, via IDE interfaces 412 (e.g., IDE interface 412-1 and IDE interface 412-N) an IDE implementing an agentic memory system. The portions of the exemplary agentic memory system provided by exemplary embodiments of the present disclosure illustrated in FIG. 4A include summarization engine 422, short-term memory 432, long-term memory 434, and memory management engine 426. As illustrated, the exemplary agentic memory system is configured to ingest, process, and store user interactions with the IDE as user preferences, patterns, contextual information, best practices information, and the like. Short-term memory 432 is preferably configured to store recent preferences, patterns, contextual information, and/or best practice information associated with a current and/or particular session, a particular user/project group/team, etc., while long-term memory 434 is preferably configured to store preferences, patterns, contextual information, and/or best practice information aggregated over multiple sessions, multiple users, across an organization, and the like. Although short-term memory 432 and long-term memory 434 are illustrated as separate components, they may be implemented as portions of one or more memory devices. In some embodiments, information stored in short-term memory 432 is not concurrently stored in long-term memory 434, and information stored in long-term memory 434 is not concurrently stored in short-term memory 432. Preferably, the information stored in long-term memory 434 may be stored as user/group/project/team profiles that specify preferences, patterns, and best practice information for each respective user/group/project/team.

As illustrated, summarization engine 422 receives interactions with the IDE from client devices 410 and generates summaries of the received user interactions with the IDE for ingesting the information into the agentic memory system. The user interactions received by the agentic memory system may include all interactions with the IDE, such as writing code, writing documentation, queries submitted via a chat interface, inline queries, adoption/rejection of recommendations, and the like. Summarization engine 422 preferably includes one or more trained machine learning models (e.g. BERT model, LLMs, encoder-decoder models, specialized models, etc.) that employ extractive and/or abstractive summarization techniques to extract relevant elements (e.g., code snippets, error messages, etc.) and identify patterns and preferences from the user interactions to condense the user interactions for efficient storage. The summaries generated by summarization engine 422 is processed by embedding generator 406 to generate multi-dimensional embedding vectors that semantically represent the generated summaries. The embedding vectors are then indexed and stored in short-term memory 432, along with metadata such as a timestamp, usage frequency information, feedback score, identification of an associated agent, and the like, as short-term contextual information associated with the user of the IDE. Preferably, short-term memory 432 may be implemented as a retrieval augmented generation (RAG) system. Accordingly, the short-term contextual information stored in short-term memory 432 can correspond to contextual information, preferences, and/or patterns for a particular coding session of a user. Alternatively and/or in addition, the short-term contextual information stored in short-term memory 432 can correspond to contextual information, preferences, patterns, and/or best practices information associated with an on-going project, a project team, and the like.

In addition to the ingestion of information into short-term memory 432, the agentic memory system includes memory management engine 426, which may include one or more trained machine learning models, probabilistic models, rule-based models, heuristic models, and the like that are configured to manage information stored in short-term memory 432, manage information stored in long-term memory 434, and manage the transfer of information between short-term memory 432 and long-term memory 434. Memory management engine 426 provides a learning pipeline that facilitates merging new information ingested into the agentic memory system, while also managing information stored in short-term memory 432 and long-term memory 434. For example, memory management engine 426 may be configured to periodically process information stored in short-term memory 432 to identify information that is to be transferred to long-term memory 434 and/or information that is to be discarded from short-term memory 432. According to aspects of the present disclosure, memory management engine 426 may identify preferences and patterns from an aggregation of information obtained from multiple sessions associated with a user across multiple dimensions (e.g., coding style, documentation preferences, error handling preferences, testing preferences, code review preferences, coding architecture/framework preferences, etc.). Additionally, the information may be aggregated across project teams, groups, organizations, etc. to identify preferences, patterns, and best practices information across such groups of users. For example, memory management engine 426 summarizes information stored in short-term memory 432 and considers parameters associated with the information such as a recency of the information, a usage frequency of the information, a feedback score associated with the information, a contextual relevance of the information, and the like to determine a relevancy of the information. According to certain implementations, the relevancy may be quantified as a relevance score, and information having a relevance score above a first threshold value may be transferred from short-term memory 432 to long-term memory 434. Alternatively and/or in addition, information having a relevance score below a second threshold value may be discarded. Optionally, information having a relevance score between the first and second thresholds may be marked and/or tagged as information that may potentially be deleted/discarded (e.g., may be deleted and/or discarded in the near future, may soon become irrelevant, may soon fall below the second threshold, etc.).

Additionally, as new information is ingested into the agentic memory system, memory management engine 426 may determine how the newly ingested information (e.g., stored in short-term memory 432) relates to information already stored in long-term memory 434. For example, it may be determined whether the new information is consistent with patterns and preferences stored in long-term memory 434, is redundant in view of information stored in long-term memory 434, conflicts with information stored in long-term memory 434, and the like. In exemplary implementations, relevance scores/weightings may be determined for information stored in long-term memory 434. The relevance scores/weightings may be determined based on various parameters, such as a time decay function (e.g., linear, exponential, Gaussian, logarithmic, logistic, etc.), feedback scores, usage frequency, and the like. The relevance scores/weightings may be used to determine information that is to be discarded from long-term memory 434 (e.g., relevance score/weighting falls below a threshold value, etc.), determine how newly ingested information is handled in the event that a conflict is identified, and the like. Additionally, memory management engine 426 may track the progress and development of users and based on a time-decay function, may archive and/or maintain a versioned history of the user's preference, patterns, etc.

As shown in FIG. 4B, the exemplary agentic memory system may also include retrieval engine 428. Retrieval engine 428 may include a machine learning agent trained to identify, retrieve, and return relevant information from short-term memory 432 and/or long-term memory 434 in view of a triggering event. For example, as a user interacts with the IDE via client device 410 and IDE interface 412, certain interactions may cause one or more of agents 402 to request relevant contextual, preference, pattern, best practices, etc. information stored in short-term memory 432 and/or long-term memory 434. Triggering interactions may include, for example, queries entered into a chat interface, inline queries, inline text, and the like. In response to the triggering event, the interaction may be used as an input to determine relevant information from short-term memory 432 and/or long-term memory 434. For example, the interaction may be summarized (e.g., by one or more of agents 402 and/or summarization engine 422), processed to generate an embedding vector that represents the semantic meaning of the interaction (e.g., by embedding generator 406), and processed using a weighted relevance function to identify and return relevant information stored in short-term memory 432 and/or long-term memory 434. In an exemplary implementation, the weighted relevance function may be represented as:

$$\begin{matrix}Relevance ( i ) = α * semantic\_similarity ( input , i ) + \\ β * temporal\_recency ( i ) + \\ γ * usage\_frequency ( i ) + \\ δ * feedback\_score ( i ) + \\ ε * interface\_alignment ( input\_interface , i\_interface )\end{matrix}$$

where i represents the information stored in multi-layer memory 130, input represents the triggering interaction, i_interface represents the feature and/or agent associated with the information stored in short-term memory 432 and/or long-term memory 434, input_interface represents the feature and/or agent associated with the triggering interaction, semantic_similarity represents an embedding similarity between the two terms, temporal_recency represents a time-decay function, usage_frequency represents a frequency at which the information is accessed, feedback_score indicates a feedback score determined based on explicit and implicit signals determined from user interactions, and interface_alignment represents a measure of the correspondence of the associated features and/or agents, and (α, β, γ, δ, ε) represent weights that are continuously optimized in view of subsequent user actions, feedback scores, and the like (as described further herein in connection with at least FIGS. 1A, 1B, 4C, and 8). Accordingly, the N number of preferences, patterns, contextual information, best practices information, etc. stored in short-term memory 432 and/or long-term memory 434 having the highest relevance scores may be retrieved and returned in response to the triggering event. Alternatively and/or in addition, the preferences, patterns, contextual information, best practices information, etc. stored in short-term memory 432 and/or long-term memory 434 having relevance scores above a threshold value may be retrieved and returned in response to the triggering event. Accordingly, agent 402 can utilize the retrieved user preferences, patterns, contextual information, best practices information, etc. in generating and serving a recommendation or suggestion in response to the trigger event. For example, the retrieved user preferences, patterns, contextual information, best practices information may be incorporated into a prompt to a LLM so that the generated recommendation or suggestion adopts the user preferences, patterns, contextual information, best practices information in the generated recommendation or suggestion. This can include preferences, patterns, and best practices information such as a level of expertise of the user (e.g., more detailed suggestions and more simplistic code suggestion vs. less detail and more complex code suggestions), the structure of code, a coding style, a communication style, the content of documentation, the testing of code, the error handling in code, the handling of code reviews, the commenting in code, and the like.

As shown in FIG. 4C, the exemplary agentic memory system may also include feedback assessment engine 424. Feedback assessment engine 424 may include one or more trained machine learning models (e.g. BERT model, LLMs, trained classifier, etc.) that are configured to process and determine the effectiveness of the retrievals based on user interactions. For example, user interactions with the IDE following a triggering event that initiated a recommendation may be ingested and processed by feedback assessment engine 424 to determine the effectiveness of the retrieved information that was used in serving the recommendations to the user. For example, the user interactions may be processed to determine whether they are explicit or implicit signals. Explicit signals may include indicators such as acceptance and/or adoption of served suggestions, refusal of served suggestions, modification of served suggestions, express feedback mechanisms (e.g., thumbs up/down), and the like, while implicit signals may be inferred from user interactions to determine satisfaction with the served recommendations. User interactions such as reformulation of queries, repetition of queries or interactions, engagement time with responses, interactions across interfaces and/or features, and the like may be considered in inferring implicit signals. Optionally, confidence scores may also be determined in connection with the inferred implicit signals, and any implicit signals having a confidence score below a threshold value may be discarded. The explicit and implicit signals may be used to, for example, determine feedback scores, continuously optimize retrieval engine 428, and the like.

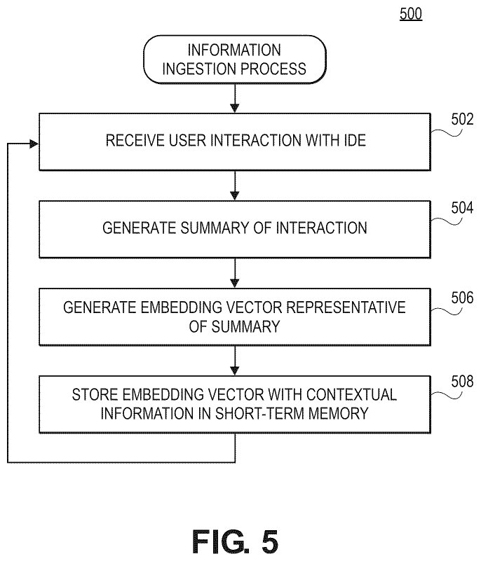

FIG. 5 is a flow diagram illustrating an exemplary information ingestion process 500, according to exemplary embodiments of the present disclosure. In exemplary implementations, process 500 may be performed by a multi-layer agentic memory system configured to ingest user interactions with an IDE to provide persistent, context-aware recommendations across various interfaces and assistance features of the IDE.

As shown in FIG. 5, information ingestion process 500 may begin with the receipt of a user interaction with an IDE, as in step 502. The received user interactions may be across various interfaces and/or features and may include all interactions with the IDE, such as writing code, writing documentation, queries submitted via a chat interface or as an inline command, adoption/rejection of recommendations, and the like. For example, entire conversations (and/or portions thereof) that the developer may have with a chat assistant provided by the IDE, code written by the developer, the adoption and/or rejection of code suggestions (e.g., generated and served by one or more agents of the IDE), and the like may all be ingested as user interactions. In step 504, the interaction may be summarized by, for example, a summarization engine, which may include one or more trained machine learning models (e.g. BERT model, LLMs, encoder-decoder models, specialized models, etc.) that employ extractive and/or abstractive summarization techniques to extract relevant elements (e.g., code snippets, error messages, etc.) and identify patterns and preferences from the user interactions to condense the user interactions for efficient storage. In some embodiments, the actual code written by the developer may be processed to determine a developer's experience level, variable/function/class names may be processed to identify the developer's preferred naming conventions, comments may be processed to determine the developer's commenting preferences, the spacing and/or indentations used may be processed to determine the developer's preferred spacing/indentation preferences, and the like. Alternatively and/or in addition, one or more interactions (and/or sequences of user interactions) may be processed to determine other coding preferences and/or styles, such as how the developer prefers to code (e.g., whether the developer prefers to first construct a skeleton of the code or prefers to start by coding the substantive portions of the code), testing preferences, documentation preferences (concise vs. verbose), etc.

The generated summary may then be processed by embedding generator to generate a multi-dimensional embedding vector that semantically represents the generated summary, as in step 506. The embedding vectors are preferably multi-dimensional vectors that represent the semantic meaning of the generated summaries. The embedding vectors are then indexed and stored in a short-term memory of a multi-layer agentic memory, along with metadata such as a timestamp, usage frequency information, feedback score, identification of an associated agent, and the like, as short-term contextual information associated with the user of the IDE, as in step 508. Preferably, the short-term memory is implemented as a retrieval augmented generation (RAG) system. In some embodiments, agents may augment recommendations and suggestions served to developers using the IDE with the developer preference and style information stored in the short-term memory. For example, the agents may serve suggestions and/or recommendations that incorporate the preferred naming conventions used by the developer, the preferred commenting styles used by the developer, the preferred spacing conventions used by the developer in response to triggering events received in connection with the developer's use of the IDE. Alternatively and/or in addition, the short-term information stored in the short-term memory can correspond to contextual information, preferences, patterns, and/or best practices information associated with an on-going project, a project team, and the like.

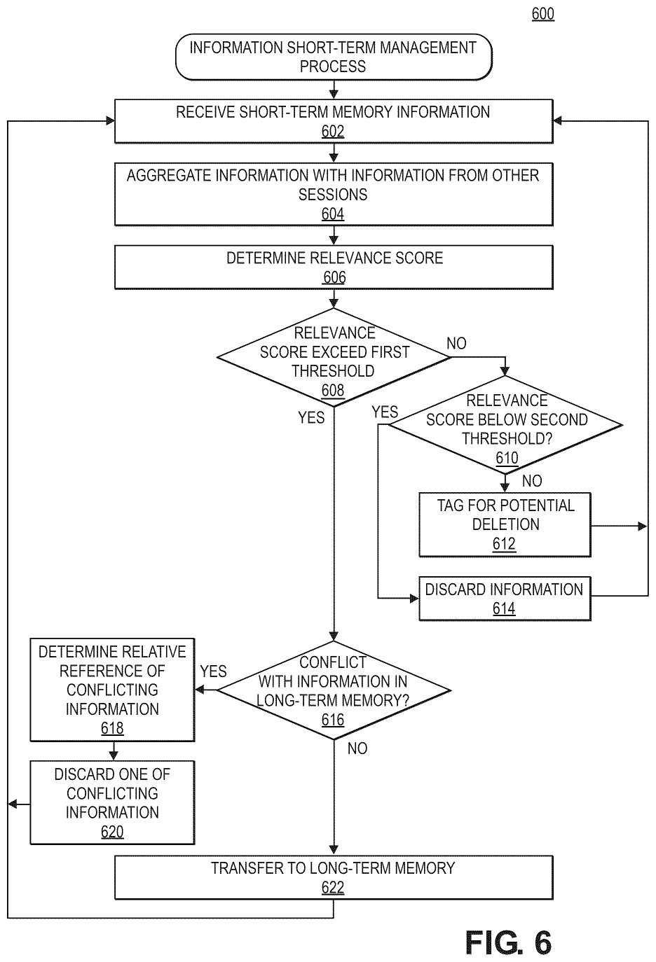

FIG. 6 is a flow diagram illustrating an exemplary short-term information management process 600, according to exemplary embodiments of the present disclosure. In exemplary implementations, process 600 may be periodically performed by a multi-layer agentic memory system to manage stored information to determine information to be transferred from a short-term memory of a multi-layer agentic memory system to a long-term memory of the multi-layer agentic memory system.

As shown in FIG. 6, process 600 may begin with the aggregation of information (e.g., stored in a short-term memory of a multi-layer agentic memory system) received across multiple sessions, as in step 602. In exemplary implementations, the information stored in the short-term memory may have been ingested in accordance with exemplary process 500. Accordingly, the information that was ingested over multiple sessions and stored in the short-term memory that represents the developer's preferences, patterns, and styles (e.g., naming conventions, commenting preferences, spacing/indentation preferences, etc.) may be aggregated, so that persistent preferences and styles of the developer may be identified. In step 604, summaries may be generated for the aggregated information to identify preferences and patterns across in multiple dimensions (e.g., coding style, documentation preferences, error handling preferences, testing preferences, code review preferences, coding architecture/framework preferences, etc.). Accordingly, the developer's preferences, patterns, and styles may be identified based on the developer's interactions with different agents of the IDE and/or different interfaces of the IDE. For example, a developer's preferences, patterns, and styles (e.g., naming conventions, commenting preferences, spacing/indentation preferences, etc.) may be identified from interactions with a test coverage, a documentation agent, and/or a code review agent based on information stored in the short-term memory in connection with code written by the developer, adoption of code suggestions, modifications to code suggestions, and/or conversations with a chat agent. Based on the generated summaries, a relevance score of the information may be determined, as in step 606. For example, the relevance score may be determined based on parameters associated with the information such as a recency of the information, a usage frequency of the information, a feedback information and/or score associated with the information, a contextual relevance of the information, and the like. In some embodiments, information in the short-term memory that is repeatedly accessed in connection with serving suggestions and recommendations to the developer, and the served suggestions and recommendations are repeatedly adopted by the developer may have a relatively higher relevance score. Conversely, information in the short-term memory that is relatively less recent and is used in connection with suggestions and recommendations that are repeatedly rejected and/or modified by the developer may have a relevance score that is relatively lower.

In step 608, it is determined whether the relevance score exceeds a first threshold value. In the event the relevance score does not exceed the first threshold value, it is determined whether the relevance score is below a second threshold value, as in step 610. In the event the relevance score is below the second threshold value, the information is discarded, as in step 614, and process 600 returns to step 602. Otherwise, the information may be tagged for potential deletion, as in step 612. For example, it may have been learned that information having a relevance score that is below a first threshold but above a second threshold has a high likelihood of no longer being relevant and/or being discarded within a certain period of time (e.g., 1 week, 1 month, etc.). Optionally, the tagging for potential deletion may also indicate that the information is to be monitored so that a trend of the relevance score may be identified. For example, if the relevance score trends higher, it may be determined that the information may exceed the first threshold after a period of time, while information having a relevance score that trends lower may be determined as likely move below the second threshold after a period of time.

In the event that the relevance score exceeds the first threshold value, in step 616, it is determined whether the information conflicts with information stored in the long-term memory of the agentic multi-layer memory system. For example, the preferences, styles, and patterns indicated by the information may be compared with the preferences, styles, and patterns indicated by information stored in the long-term memory of the agentic multi-layer memory system. In some embodiments, examples of conflicting information may include, for example, indications from the information that the developer is an experienced developer, while the information stored in the long-term memory indicates that the developer is inexperienced. By way of other examples, the information may indicate a preference for a certain naming convention, commenting style, development style, etc., while the information stored in the long-term memory indicates a preference for a different certain naming convention, commenting style, development style, etc. If there is no conflict, the information is transferred to long-term memory, as in step 622, and process 600 returns to step 602.

Otherwise, if it is determined that there is conflicting information, the relative relevance of the conflicting information may be determined, as in step 618. For example, the relevance scores and/or weightings may be determined for the conflicting information stored in the long-term memory of the multi-layer agentic memory system. The relevance scores/weightings may be determined based on various parameters, such as a time decay function (e.g., linear, exponential, Gaussian, logarithmic, logistic, etc.), feedback scores, usage frequency, and the like. The relevance scores/weightings may be used to determine information which of the conflicting information is to be discarded, as in step 620. Accordingly, the relative relevancy of the conflicting information may be used to determine which information to maintain in the long-term memory of the multi-layer agentic memory system. In an illustrative example, information stored the long-term memory of the multi-layer agentic memory system that has been consistently maintained with a relatively higher usage frequency and feedback scores may be maintained in the long-term memory of the multi-layer agentic memory system over new information that has relatively lower usage frequency and feedback scores. The usage frequency may correspond to how many times the information is returned in response to a triggering event to generate and serve suggestions and/or recommendations to developers and the feedback scores may reflect the developer's response to the served suggestions and/or recommendations (e.g., adoption of the served suggestions and/or recommendations, modifications to the served suggestions and/or recommendations, other interactions with the IDE after the suggestions and/or recommendations have been served, etc.). For example, if information in the long-term memory indicates a user preference for a certain naming convention that has been repeatedly accessed in connection with serving suggestions and recommendations to the developer over a long period of time, and the served suggestions and recommendations are repeatedly adopted by the developer, such information may be maintained in the long-term memory over information in the short-term memory that is relatively recent and was not frequently accessed indicating that the developer prefers a different naming convention.

However, there may be circumstances where an overriding condition may exist. For example, although the new information may have relatively lower relevancy, as measured by usage frequency and feedback scores, the new information may have relatively higher contextual relevance to best practices information for the project, group, team, or organization with which the user is associated, while the information stored the long-term memory of the multi-layer agentic memory system is in conflict with best practices information for the project, group, team, or organization with which the user is associated. Accordingly, in such a circumstance, the overriding condition may dictate that the new information is transferred to the long-term memory of the multi-layer agentic memory system and the conflicting information that was previously stored in the long-term memory of the multi-layer agentic memory system may be discarded. Subsequently, process 600 returns to step 602.

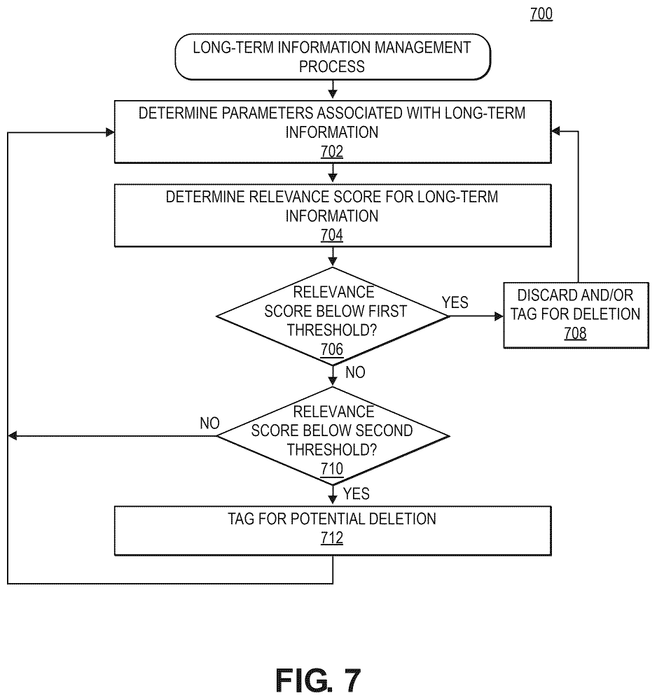

FIG. 7 is a flow diagram illustrating an exemplary long-term information management process 700, according to exemplary embodiments of the present disclosure. In exemplary implementations, process 700 may be periodically performed by a multi-layer agentic memory system to manage stored information by a long-term memory of the multi-layer agentic memory system.

In some embodiments, the management of information stored in the long-term memory may facilitate ensuring the relevance of the information stored and maintained in the long-term memory as developer preferences, styles, and experience evolve over time. For example, as a developer gains experience over time, information indicating the inexperience of the developer may be discarded from the long-term memory as new information indicating the developer's increased experience is obtained. Further, as a developer gains experience, the developer's preferences and style may also change as the developer gains further experience. Accordingly, the outdated preferences and style may be discarded from the long-term memory as more recent relevant information is ingested and acquired.

As shown in FIG. 7, process 700 may begin with step 702, which may include determining parameters associated with long-term information stored in the long-term memory of the multi-layer agentic memory system. For example, parameters such as a time decay function (e.g., linear, exponential, Gaussian, logarithmic, logistic, etc.) associated with the information, feedback scores and/or information associated with the information, usage frequency associated with the information, and the like may be determined.

Based on the determined parameters, a relevance score may be determined, and, in step 706, it may be determined whether the relevance score exceeds a threshold value. If the relevance score does not exceed a threshold value, the information is discarded, versioned, archived, etc., as in step 708, otherwise, process 700 proceeds to step 710, where it is determined whether the relevance score is below a second threshold. If the relevance score is below the second threshold, the information may be tagged for potential deletion, as in step 712. For example, it may have been learned that information having a relevance score that is below a first threshold but above a second threshold has a high likelihood of no longer being relevant and/or being discarded within a certain period of time (e.g., 1 week, 1 month, etc.). Optionally, the tagging for potential deletion may also indicate that the information is to be monitored so that a trend of the relevance score may be identified. For example, if the relevance score trends higher, it may be determined that the information may exceed the first threshold after a period of time, while information having a relevance score that trends lower may be determined as likely move below the second threshold after a period of time.

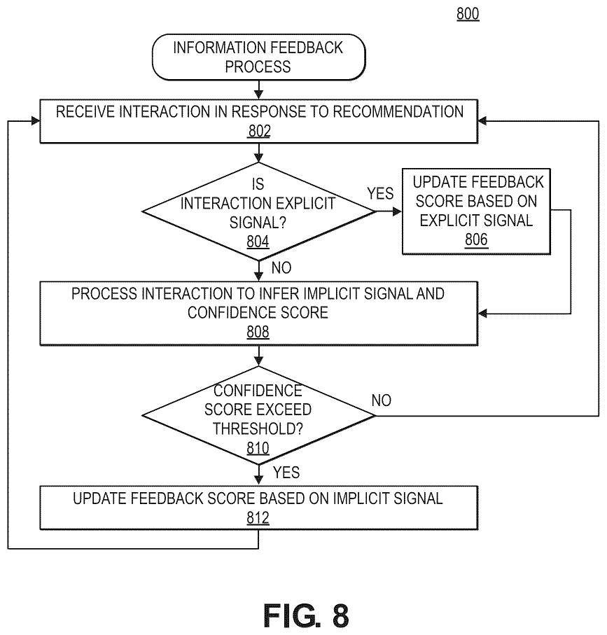

FIG. 8 is a flow diagram illustrating an exemplary information feedback process 800, according to exemplary embodiments of the present disclosure. In exemplary implementations, process 800 may be performed by a multi-layer agentic memory system to determine feedback scores and information to associate with information stored by the multi-layer agentic system and continuously update and optimize the multi-layer agentic system.

As shown in FIG. 8, an example process 800 may begin with the receipt of a user interaction in response to a recommendation (e.g., code suggestion, suggested documentation for code, suggested unit tests, code reviews by suggestions, etc.) served to a user, as in step 802. The recommendation served prior to step 802 may include a code suggestion modified with the user's preference or customized pattern retrieved from either long-term memory or short-term memory. For example, the code suggestion may include certain syntactical arrangement/placement that is unique to the user/project/organization (or presented in a format that conforms with the team's best practice). In step 804, it may be determined whether the interaction is an explicit feedback signal. For example, explicit signals may include the user accepting the code suggestion that has been customized with user's preference or the user rejecting the customized code suggestion. In some embodiments, the user may use the chat function in IDE to give explicit feedback to the customized code suggestions such as applying a thumbs up/down indication to the recommendation.

In the event that the interaction is an explicit signal, process 800 proceeds to step 806, where a feedback score and/or feedback information may be updated based on the explicit signal. In some embodiments, if the user accepts the code suggestion that has been modified with the user reference, the frequency and relevance score of the customization/pattern will increase. It acts as a positive reinforcement learning for the system. In some embodiments, once the score reaches a certain threshold, the modification/coding pattern that has been in the short-term memory can be transferred to the long-term memory. In contrast, if the user repeatedly rejects a certain code suggestion, the relevance score of such pattern/customization would decrease accordingly. When the relevance score decreased to a certain level, such pattern/customization may be tagged for potential removal/deletion.

As discussed above, not all users'feedback are explicit. In some instances, the user may reformulate the queries or change the suggested code. In step 808, process 800 may infer implicit signals in the interaction, as well as a confidence score associated with the inference. In some embodiments, the process evaluates explicit signals before assessing implicit signals. In some embodiments, the process can evaluate both explicit and implicit signals concurrently. Continuing with the example above, after receiving a customized code suggestion, the user may modify or rewrite the customized code suggestion to another format. For instance, the user may rearrange the syntactical structure to another format, delete a portion of the customized code suggestion, or break the suggested code into multiple lines. User's interaction may not qualify as an outright acceptance of rejection of the recommendation. In such instances, step 808 may call one or more trained machine learning models, such as an LLM, a BERT model, or a trained classifier, to assess whether the interaction is closer to a positive reinforcement, negative feedback, or neutral. One way of doing is by calculating a confidence score. For example, if the user merely added a minor modification (e.g., remove one syntax), such modification may be calculated as positive feedback. If such minor modification occurred to a certain pre-defined frequency, the short-term memory will update such customization with the new modification. After the update, if the user consistently accepts the changed customization, such changed customization may then be moved to the long-term memory. In another scenario, if the user rewrites the query several times while not accepting the code suggestions, the machine learning model may categorize such interaction as negative feedback. In such case, the relevancy score for the related customization may drop in the short-term or long-term memory. There can be a scenario where the process does not find the confidence score to be high enough to categorize the interaction as either positive or negative. For example, the user may be changing a portion of the code suggestion to different formats in multiple sequential turns. In such case, process 800 will not update the relevancy score in the short-term or long-term memory until a certain pattern is detected. Going back to FIG. 8, when the confidence score exceeds a threshold value, as determined in step 810, the feedback score and/or information is updated based on the implicit signal, and process 800 returns to step 802. Otherwise, process 800 returns to step 802.

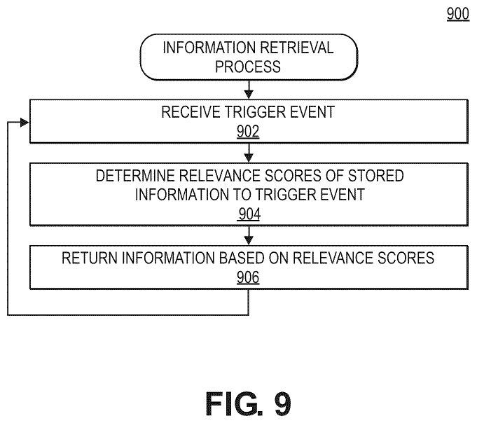

FIG. 9 is a flow diagram illustrating an exemplary information retrieval process 900, according to exemplary embodiments of the present disclosure. In exemplary implementations, process 900 may be performed by a multi-layer agentic memory system to retrieve relevant information to facilitate the generation and serving of recommendations by agent applications of the IDE.

As shown in FIG. 9, process 900 may begin with the receipt of a trigger event. For example, certain user interactions may trigger an agent application to request relevant contextual, preference, pattern, best practices, etc. information stored in the multi-layer agentic memory system. Triggering interactions may include, for example, queries entered into a chat interface, inline queries, inline text, and the like. In an illustrative example, a developer may open a chat agent and provide a query in connection with a task the developer is trying to complete. For example, the query may indicate that the developer needs to create documentation for the code that the developer is working on. Alternatively and/or in addition, the trigger event may be actual code that the developer is writing.

In response to the triggering event, the interaction may be used as an input to determine relevant information from the multi-layer agentic memory system. As in step 904, relevance scores may be determined for the information stored in the multi-layer agentic memory system to the trigger event. For example, the trigger event interaction may be summarized, processed to generate an embedding vector that represents the semantic meaning of the trigger event interaction, and processed using a weighted relevance function to identify and return relevant information stored in the multi-layer agentic memory system. In an exemplary implementation, the weighted relevance function may be represented as:

$$\begin{matrix}Relevance ( i ) = α * semantic\_similarity ( input , i ) + \\ β * temporal\_recency ( i ) + \\ γ * usage\_frequency ( i ) + \\ δ * feedback\_score ( i ) + \\ ε * interface\_alignment ( input\_interface , i\_interface )\end{matrix}$$

where i represents the information stored in the multi-layer agentic memory system, input represents the triggering interaction, i_interface represents the feature and/or agent associated with the information stored in the multi-layer agentic memory system, input_interface represents the feature and/or agent associated with the triggering interaction, semantic_similarity represents an embedding similarity between the two terms, temporal_recency represents a time-decay function, usage_frequency represents a frequency at which the information is accessed, feedback_score indicates a feedback score determined based on explicit and implicit signals determined from user interactions, and interface_alignment represents a measure of the correspondence of the associated features and/or agents, and (α, β, γ, δ, ε) represent weights that are continuously optimized in view of subsequent user actions, feedback scores, and the like. In step 906, the identified information may be retrieved and returned. For example, the N number of preferences, patterns, contextual information, best practices information, etc. stored in the multi-layer agentic memory system having the highest relevance scores may be retrieved and returned in response to the triggering event. Alternatively and/or in addition, the preferences, patterns, contextual information, best practices information, etc. stored in the multi-layer agentic memory system having relevance scores above a threshold value may be retrieved and returned in response to the triggering event. Accordingly, the agent can utilize the retrieved user preferences, patterns, contextual information, best practices information, etc. in generating and serving a recommendation or suggestion in response to the trigger event.

Continuing the illustrative example where the developer is creating documentation for the code, the summary of the triggering event may indicate that a README file is to be created. Accordingly, in retrieving and returning relevant information, in some embodiments, the developer's preferences and styles in connection with determining documentation, such as README files, may be identified and retrieved from the short-term and long-term memory. The retrieved user preferences, patterns, contextual information, best practices information may be incorporated into a prompt to a LLM so that the generated recommendation or suggestion adopts the user preferences, patterns, contextual information, best practices information in the generated recommendation or suggestion. This can include preferences, patterns, and best practices information such as a level of expertise of the user (e.g., more detailed suggestions and more simplistic code suggestion vs. less detail and more complex code suggestions), the structure of code, a coding style, a communication style, the content of documentation, the testing of code, the error handling in code, the handling of code reviews, the commenting in code, and the like. Accordingly, in the illustrative example, the developer's preferences and styles (e.g., syntax, communication style, etc.) in connection with creating documentation, such as a README file, are incorporated into the LLM prompt, so that the generative model generates a README file that incorporates the developer's preferences and styles (e.g., syntax, communication style, etc.).

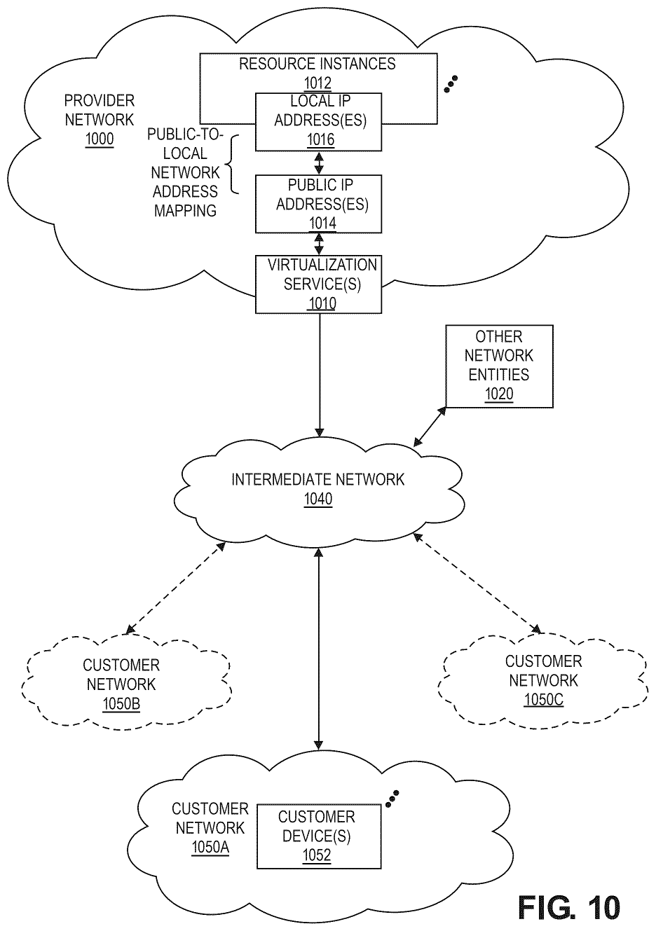

FIG. 10 is a block diagram illustrating an exemplary provider network (or “service provider system”) environment, according to exemplary embodiments of the present disclosure.

As shown in FIG. 10, provider network 1000 can provide resource virtualization to customers via one or more virtualization services 1010 that allow customers to purchase, rent, or otherwise obtain instances 1012 of virtualized resources, including but not limited to computation and storage resources, implemented on devices within the provider network or networks in one or more data centers. Local Internet Protocol (IP) addresses 1016 can be associated with the resource instances 1012; the local IP addresses are the internal network addresses of the resource instances 1012 on the provider network 1000. In some examples, the provider network 1000 can also provide public IP addresses 1014 and/or public IP address ranges (e.g., Internet Protocol version 4 (IPv4) or Internet Protocol version 6 (IPv6) addresses) that customers can obtain from the provider 1000.

Conventionally, the provider network 1000, via the virtualization services 1010, can allow a customer of the service provider (e.g., a customer that operates one or more customer networks 1050A, 1050B, 1050C (or “client networks”) including one or more customer device(s) 1052) to dynamically associate at least some public IP addresses 1014 assigned or allocated to the customer with particular resource instances 1012 assigned to the customer. The provider network 1000 can also allow the customer to remap a public IP address 1014, previously mapped to one virtualized computing resource instance 1012 allocated to the customer, to another virtualized computing resource instance 1012 that is also allocated to the customer. Using the virtualized computing resource instances 1012 and public IP addresses 1014 provided by the service provider, a customer of the service provider such as the operator of the customer network(s) 1050A-1050C can, for example, implement customer-specific applications and present the customer's applications on an intermediate network 1040, such as the Internet. Other network entities 1020 on the intermediate network 1040 can then generate traffic to a destination public IP address 1014 published by the customer network(s) 1050A-1050C; the traffic is routed to the service provider data center, and at the data center is routed, via a network substrate, to the local IP address 1016 of the virtualized computing resource instance 1012 currently mapped to the destination public IP address 1014. Similarly, response traffic from the virtualized computing resource instance 1012 can be routed via the network substrate back onto the intermediate network 1040 to the source entity 1020.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 1000; a customer can then assign their allocated public IP addresses to particular resource instances allocated to the customer. These public IP addresses can be referred to as customer public IP addresses, or simply customer IP addresses. Instead of being assigned by the provider network 1100 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

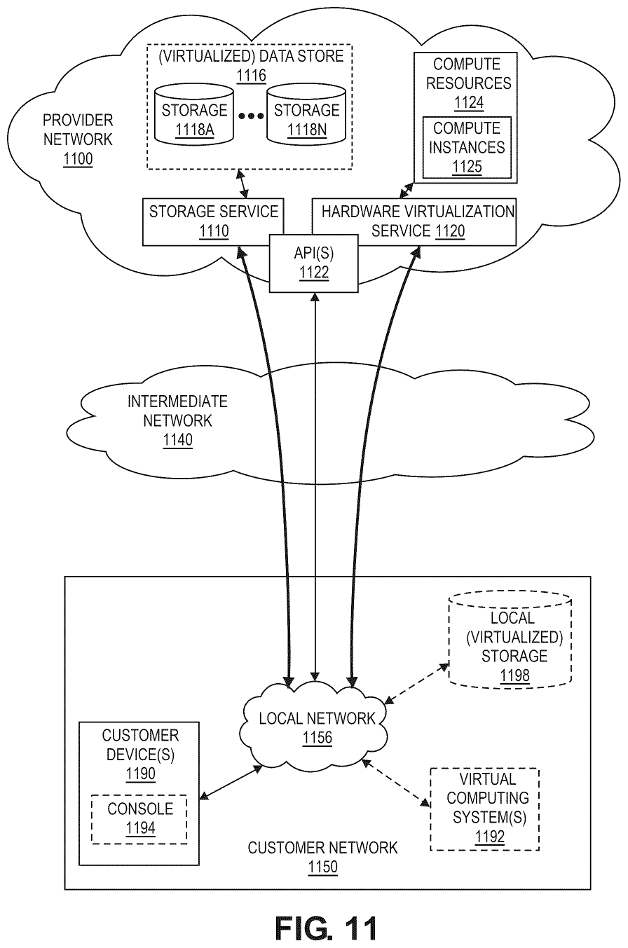

FIG. 11 is a block diagram illustrating an exemplary provider network environment 1100 that provides a storage service and a hardware virtualization service to customers, according to exemplary embodiments of the present disclosure.

As shown in FIG. 11, hardware virtualization service 1120 provides multiple compute resources 1124 (e.g., compute instances 1125, such as VMs) to customers. The compute resources 1124 can, for example, be provided as a service to customers of a provider network 1100 (e.g., to a customer that implements a customer network 1150). Each computation resource 1124 can be provided with one or more local IP addresses. The provider network 1100 can be configured to route packets from the local IP addresses of the compute resources 1124 to public Internet destinations, and from public Internet sources to the local IP addresses of the compute resources 1124.

The provider network 1100 can provide the customer network 1150, for example coupled to an intermediate network 1140 via a local network 1156, the ability to implement virtual computing systems 1192 via the hardware virtualization service 1120 coupled to the intermediate network 1140 and to the provider network 1100. In some examples, the hardware virtualization service 1120 can provide one or more APIs 1122, for example a web services interface, via which the customer network 1150 can access functionality provided by the hardware virtualization service 1120, for example via a console 1194 (e.g., a web-based application, standalone application, mobile application, etc.) of a customer device 1190. In some examples, at the provider network 1100, each virtual computing system 1192 at the customer network 1150 can correspond to a computation resource 1124 that is leased, rented, or otherwise provided to the customer network 1150.

From an instance of the virtual computing system(s) 1192 and/or another customer device 1190 (e.g., via console 1194), the customer can access the functionality of a storage service 1110, for example via the one or more APIs 1122, to access data from and store data to storage resources 1118A-1118N of a virtual data store 1116 (e.g., a folder or “bucket,” a virtualized volume, a database, etc.) provided by the provider network 110. In some examples, a virtualized data store gateway (not shown) can be provided at the customer network 1150 that can locally cache at least some data, for example frequently accessed or critical data, and that can communicate with the storage service 1110 via one or more communications channels to upload new or modified data from a local cache so that the primary store of data (the virtualized data store 1116) is maintained. In some examples, a user, via the virtual computing system 1192 and/or another customer device 1190, can mount and access virtual data store 1116 volumes via the storage service 1110 acting as a storage virtualization service, and these volumes can appear to the user as local (virtualized) storage 1198.

While not shown in FIG. 11, the virtualization service(s) can also be accessed from resource instances within the provider network 1100 via the API(s) 1122. For example, a customer, appliance service provider, or other entity can access a virtualization service from within a respective virtual network on the provider network 1100 via the API(s) 1122 to request allocation of one or more resource instances within the virtual network or within another virtual network.

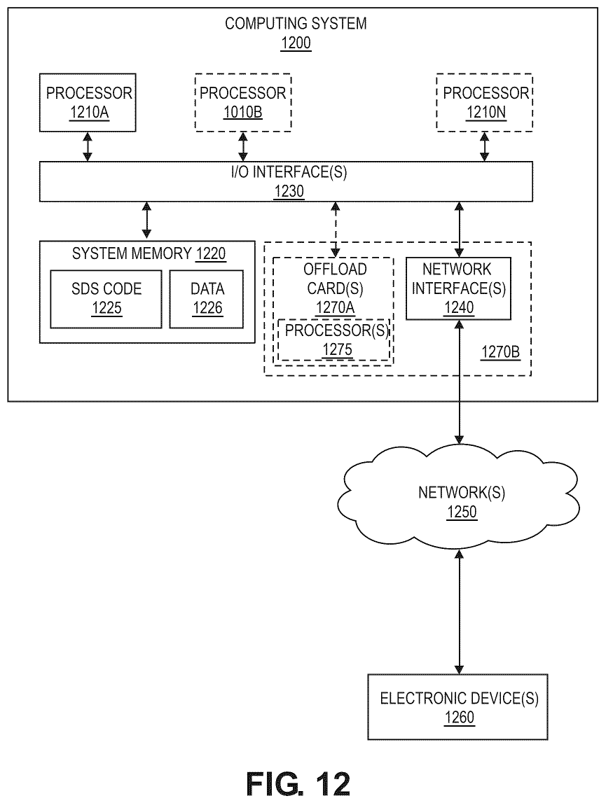

FIG. 12 is a block diagram illustrating an exemplary computer system, according to exemplary embodiments of the present disclosure.

In some examples, a system that implements a portion or all of the techniques described herein can include a general-purpose computer system, such as the computer system 1200 (also referred to as a computing device or electronic device) illustrated in FIG. 12, that includes, or is configured to access, one or more computer-accessible media. In the illustrated example, the computer system 1200 includes one or more processors 1210 coupled to a system memory 1220 via an input/output (I/O) interface 1230. The computer system 1200 further includes a network interface 1240 coupled to the I/O interface 1230. While FIG. 12 shows the computer system 1200 as a single computing device, in various examples the computer system 1200 can include one computing device or any number of computing devices configured to work together as a single computer system 1200.

In various examples, the computer system 1200 can be a uniprocessor system including one processor 1210, or a multiprocessor system including several processors 1210A 1210N (e.g., two, four, eight, or another suitable number). The processor(s) 1210 can be any suitable processor(s) capable of executing instructions. For example, in various examples, the processor(s) 1210 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1210 can commonly, but not necessarily, implement the same ISA.

The system memory 1220 can store instructions and data accessible by the processor(s) 1210. In various examples, the system memory 1220 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1220 as SDS code 1225 (e.g., executable to implement, in whole or in part, an LLM service such as those described herein) and data 1226.

In some examples, the I/O interface 1230 can be configured to coordinate I/O traffic between the processor 1210, the system memory 1220, and any peripheral devices in the device, including the network interface 1240 and/or other peripheral interfaces (not shown). In some examples, the I/O interface 1230 can perform any necessary protocol, timing, or other data transformations to convert data signals from one component (e.g., the system memory 1220) into a format suitable for use by another component (e.g., the processor 1210). In some examples, the I/O interface 1230 can include support for devices attached through various types of peripheral buses, such as a variant of the Peripheral Component Interconnect (PCI) bus standard or the Universal Serial Bus (USB) standard, for example. In some examples, the function of the I/O interface 1230 can be split into two or more separate components, such as a north bridge and a south bridge, for example. Also, in some examples, some or all of the functionality of the I/O interface 1230, such as an interface to the system memory 1220, can be incorporated directly into the processor 1210.

The network interface 1240 can be configured to allow data to be exchanged between the computer system 1200 and other electronic devices 1260 attached to a network or networks 1250, such as other computer systems or devices as illustrated in FIG. 1A, for example. In various examples, the network interface 1240 can support communication via any suitable wired or wireless general data networks, such as types of Ethernet network, for example. Additionally, the network interface 1240 can support communication via telecommunications/telephony networks, such as analog voice networks or digital fiber communications networks, via storage area networks (SANs), such as Fibre Channel SANs, and/or via any other suitable type of network and/or protocol.

In some examples, the computer system 1200 includes one or more offload cards 1270A or 1270B (including one or more processors 1275, and possibly including the one or more network interfaces 1240) that are connected using the I/O interface 1230 (e.g., a bus implementing a version of the Peripheral Component Interconnect-Express (PCI-E) standard, or another interconnect such as a QuickPath interconnect (QPI) or UltraPath interconnect (UPI)). For example, in some examples the computer system 1200 can act as a host electronic device (e.g., operating as part of a hardware virtualization service) that hosts compute resources such as compute instances, and the one or more offload cards 1270A or 1270B execute a virtualization manager that can manage compute instances that execute on the host electronic device. As an example, in some examples the offload card(s) 1270A or 1270B can perform compute instance management operations, such as pausing and/or un-pausing compute instances, launching and/or terminating compute instances, performing memory transfer/copying operations, etc. These management operations can, in some examples, be performed by the offload card(s) 1270A or 1270B in coordination with a hypervisor (e.g., upon a request from a hypervisor) that is executed by the other processors 1210A-1210N of the computer system 1200. However, in some examples the virtualization manager implemented by the offload card(s) 1270A or 1270B can accommodate requests from other entities (e.g., from compute instances themselves), and cannot coordinate with (or service) any separate hypervisor.

In some examples, the system memory 1220 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 1200 via the I/O interface 1230. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computer system 1200 as the system memory 1220 or another type of memory. Further, a computer-accessible medium can include transmission media or signals such as electrical, electromagnetic, or digital signals, conveyed via a communication medium such as a network and/or a wireless link, such as can be implemented via the network interface 1240.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response to requests from user devices, such as by executing one or more Web applications that can be implemented as one or more scripts or programs written in any programming language, such as Java®, C, C #or C++, or any scripting language, such as Perl®, Python®, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1218A-1218N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. An agentic memory system, comprising:
a first memory having a first portion and a second portion, the first portion storing a first set of short-term information and the second portion storing a second set of long-term information;
a memory management system including one or more processors and a second memory storing program instructions that, when executed by the one or more processors, cause the one or more processors to at least:
ingest a user interaction with an integrated development environment (IDE) and cause a representation of the user interaction to be stored in the first portion of the memory to be included in the first set of short-term information;
manage at least one of the first set of short-term information or the second set of long-term information, wherein managing at least one of the first set of short-term information or the second set of long-term information includes at least one of:
transferring, based at least in part on the first set of short-term information, at least a portion of the first set of short-term information from the first portion of the first memory to the second portion of the first memory to be included in the second set of long-term information; or
deleting, based at least in part on the second set of long-term information, at least a portion of the second set of long-term information from the second portion of the first memory; and
retrieve, in response to a triggering event, responsive information from at least one of the first portion of the first memory or the second portion of the first memory based at least in part on a relevance of the triggering event to at least one of the first set of short-term information or the second set of long-term information.

2. The agentic memory system of claim 1, wherein ingesting the user interaction and causing the representation of the user interaction to be stored in the first portion of the memory as the first set of short-term information includes:
receiving the user interaction in the IDE;
generating, based at least in part on the user interaction, a summary of the user interaction;
generating, based at least in part on the summary, an embedding vector that semantically represents the summary; and
causing the embedding vector to be stored in the first portion of the memory as part of the first set of short-term information.

3. The agentic memory system of claim 1, wherein transferring at least a portion of the first set of short-term information from the first portion of the first memory to the second portion of the first memory includes:
aggregating some of the set of short-term information obtained across multiple sessions;
identifying, based at least in part on the aggregation of the set of short-term information, at least one pattern in the aggregation of the set of short-term information; and
transferring, based at least in part on the identified at least one pattern, the at least a portion of the first set of short-term information from the first portion of the first memory to the second portion of the first memory.

4. The agentic memory system of claim 3, wherein:
the multiple sessions is across a plurality of users; and
the at least one pattern corresponds to a best practice information for the plurality of users.

5. The agentic memory system of claim 1, wherein the program instructions of the memory management system, when executed by the one or more processors, further cause the one or more processors to at least:
receive a responsive interaction to a recommendation generated based at least in part on the responsive information; and
update, based at least in part on the responsive interaction, at least one of:
the first set of short-term information stored in the first portion of the first memory;
the second set of long-term information stored in the second portion of the first memory; or
a relevance function used in determining the relevance of the triggering event.

6. A computer-implemented method, comprising:
receiving, at a memory system, a first user interaction via an integrated development environment (IDE), wherein the memory system includes a storage function configured to separately store short-term information and long-term information in different memory spaces;
storing a first representation of the first user interaction as a first short-term information in a short-term memory space;
aggregating a plurality of short-term information stored in the memory system to identify a first user preference in the aggregation of the plurality of short-term information, wherein the plurality of short-term information includes the first short-term information; and
transferring, based at least in part on the identification of the user preference, the first short-term information from the short-term memory space to a long-term memory space to be stored as first long-term information.

7. The computer-implemented method of claim 6, further comprising:
receiving, from the IDE in response to a trigger event and at the multi-layer agentic memory system, a request for user preference information;
determining, based at least in part on the trigger event, a second user preference from at least one of short-term information stored in the different memory spaces; and
providing the second user preference to the IDE to be used in generating a suggestion to a user of the IDE.

8. The computer-implemented method of claim 7, wherein determining the user preference is based at least in part on at least one of:
a first semantic similarity between the trigger event and the short-term information;
a second semantic similarity between the trigger event and the long-term information;
a first recency associated with the short-term information;
a second recency associated with the long-term information;
a first usage frequency associated with the short-term information;
a second usage frequency associated with the long-term information;
a first feedback score associated with the short-term information;
a second feedback score associated with the long-term information;
a first interface alignment score associated with the short-term information; or
a second interface alignment score associated with the long-term information.

9. The computer-implemented method of claim 7, wherein determining the second user preference is based at least in part on at least one of a current project in the IDE, an agent type of the agent application, a programming language of the current project, or an interface type associated with the trigger event.

10. The computer-implemented method of claim 7, further comprising:
receiving a responsive interaction to the suggestion generated by the agent application; and
updating, based at least in part on the responsive interaction, at least one of the short-term information stored in the different memory spaces.

11. The computer-implemented method of claim 7, further comprising:
receiving a responsive interaction to the suggestion generated by the agent application; and
updating, based at least in part on the responsive interaction, a relevance function used to determine the second user preference.

12. The computer-implemented method of claim 10, wherein the responsive interaction includes at least one of an explicit signal or an inferred implicit signal.

13. The computer-implemented method of claim 6, further comprising:
receiving, at the memory system, a second user interaction in the IDE;
storing a second representation of the second user interaction to be written to the short-term memory space as second short-term information;
aggregating a second plurality of short-term information stored in the short-term memory space to identify a third user preference in the aggregation of the second plurality of short-term information, wherein the second plurality of short-term information includes the second short-term information;
determining a conflict between the second short-term information and second long-term information stored in a long-term memory space;
determining, in response to the determination of the conflict, a relative relevance between the second short-term information and second long-term information; and
based at least in part on the relative relevance, one of:
deleting the second short-term information from the short-term memory space;
marking the second short-term information from the short-term memory space for potential deletion from the short-term memory space; or
transferring the second short-term information from the short-term memory space to the long-term memory space to be stored as third long-term information and deleting the second long-term information from long-term memory space.

14. The computer-implemented method of claim 13, wherein the relative relevance is determined based at least in part on at least one of:
a first feedback score associated with the second short-term information;
a second feedback score associated with the second long-term information;
a recency associated with the second long-term information;
a first contextual relevance associated with the second short-term information; or
a second contextual relevance associated with the second long-term information.

15. The computer-implemented method of claim 6, wherein the plurality of short-term information is aggregated over a plurality of users so that the long-term information represents best practices information across the plurality of users.

16. A non-transitory computer-readable medium storing program instructions thereon that, when executed by one or more processors, cause the one or more processors to perform step, comprising:
receiving, by a memory system and in response to a trigger event, a request from an agent application of an integrated development environment (IDE) for user preference information, wherein the memory system includes separate memory spaces for storing short-term information and long-term information;
determining, based at least in part on the trigger event, a user preference from at least one of short-term information stored in short-term memory space or long-term information stored in a long-term memory space;
providing the user preference to the agent application to be used in generating a suggestion to a user of the IDE;
receiving a responsive interaction to the suggestion generated by the agent application; and
updating, based at least in part on the responsive interaction, at least one of the short-term information stored in the short-term memory space or long-term information stored in the long-term memory space.

17. The transitory computer-readable medium of claim 16, wherein the program instructions include further instructions that, when executed by the one or more processors, cause the one or more processors to further perform steps comprising:
updating, based at least in part on the responsive interaction, a relevance function used to determine the user preference.

18. The transitory computer-readable medium of claim 16, wherein:
the program instructions include further instructions that, when executed by the one or more processors, cause the one or more processors to further perform steps comprising inferring an implicit signal from the responsive interaction; and
updating the at least one of the short-term information or long-term information is based at least in part on the implicit signal.

19. The transitory computer-readable medium of claim 16, wherein the program instructions include further instructions that, when executed by the one or more processors, cause the one or more processors to further perform steps comprising:
aggregating a plurality of short-term information stored in the short-term memory space to identify a pattern in the aggregation of the plurality of short-term information;
transferring, based at least in part on the identification of the pattern, the first short-term information from the short-term memory space to the long-term memory space to be stored as first long-term information; and
deleting, based at least in part on the transferred the first short-term information and a recency of second long-term information, the second long-term information from the long-term memory space.

20. The transitory computer-readable medium of claim 16, wherein determining the user preference is based at least in part on at least one of:
a semantic similarity between the trigger event and the user preference;
a recency associated with the user preference;
a usage frequency associated with the user preference;
a feedback score associated with the user preference; or
an interface alignment of the user preference and an agent type of the agent application.
